(19) United States
(12) Patent Application Publication
(10) Pub. No.: US 2026/0340149 A1
(43) Pub. Date: Oct. 29, 2026

(54) REAL-TIME POLICY ENFORCEMENT THROUGH SEQUENCE-AWARE RISK ASSESSMENT AND INTERVENTION FOR THIRD-PARTY SOFTWARE INTERFACES

(71) Applicant: CyberSecLabs, Inc., Santa Barbara, CA (US)

(72) Inventors: Samuel Wick, Santa Barbara, CA (US); Josué David Figueroa, Santa Barbara, CA (US); Mohammed Amine Allouah, Santa Barbara, CA (US); Richard Bowman, Santa Barbara, CA (US)

(21) Appl. No.: 19/639,091

(22) Filed: Apr. 3, 2026

Related U.S. Application Data
(60) Provisional application No. 63/783,083, filed on Apr. 3, 2025.

(51) Int. Cl. G06F 21/57

(52) U.S. Cl. CPC G06F 21/577; G06F 2221/033

(57) ABSTRACT

A computer-implemented system performs policy enforcement for third-party software interfaces. Processors obtain action data indicative of a proposed action within a workflow, generate structured observations identifying an action type, a context of the proposed action, and one or more interface or system elements associated with the proposed action, and retrieve sequence context associated with the proposed action from prior workflow activity across one or more applications or services. The processors evaluate the proposed action against policy constraints using the structured observations and the sequence context to generate a risk output, select an intervention modality based at least in part on the risk output, and cause performance of the intervention modality. The intervention modality includes a user-interface intervention associated with a target interface element. In some embodiments, the intervention modality includes a machine-readable intervention response that alters, delays, denies, or redirects execution of the proposed action by an artificial intelligence agent.

### CROSS-REFERENCE TO RELATED APPLICATIONS

This application claims priority to U.S. Provisional Patent Application No. 63/783,083, filed Apr. 3, 2025, entitled “Augmenting Third-Party Software User Interfaces Via Overlays,” the disclosure of which is hereby incorporated by reference herein in its entirety.

### BACKGROUND

### Technical Field

The present disclosure relates generally to computer-implemented security and interface control systems, and more particularly to real-time policy enforcement, sequence-aware risk assessment, and intervention for third-party software interfaces.

### Description of Related Art

Human error and oversight have emerged as the leading contributors to cybersecurity incidents, with recent data indicating that approximately 90% of data breaches in 2024 involved some form of human involvement. As digital systems and workflows become more complex, individual users are increasingly tasked with making high-stakes decisions related to data security, privacy, and compliance—often without sufficient contextual support from the software they use.

To mitigate these risks, organizations frequently rely on training programs intended to educate employees about best practices and regulatory obligations. However, these programs are often time-consuming, burdensome, and of limited effectiveness in preventing real-time errors. Users remain susceptible to lapses in judgment, inadvertent disclosures, or procedural missteps, particularly in dynamic or high-pressure environments.

The consequences of such errors can be significant for both individuals and organizations, exposing them to regulatory penalties, financial losses, and long-term reputational harm. The increasing reliance on human vigilance as a primary line of defense underscores the urgent need for technical solutions that can reduce or eliminate dependency on user discretion in high-risk contexts.

### SUMMARY

The following is a non-exhaustive list of some aspects of the present techniques. These and other aspects are described in the following disclosure.

In some aspects, the techniques described herein relate to a computer-implemented process, including: monitoring, by a computing system, a workflow associated with a user at a computing environment; obtaining, by the computing system, action data indicative of a proposed action within the workflow; generating, by the computing system from the action data, structured observations identifying at least an action type, a context of the proposed action, and one or more interface or system elements associated with the proposed action; retrieving, by the computing system from a data structure storing prior workflow activity, sequence context associated with the proposed action, wherein the sequence context includes one or more prior actions related to the proposed action across one or more applications or services; evaluating, by the computing system, the proposed action against policy constraints using the structured observations and the sequence context to generate a risk output indicative of whether the proposed action presents a policy violation risk; selecting, by the computing system and based at least in part on the risk output, an intervention modality for the proposed action; and causing, by the computing system, performance of the intervention modality.

Some aspects include a tangible, non-transitory, machine-readable medium storing instructions that when executed by a data processing apparatus cause the data processing apparatus to perform operations including the above-mentioned processes.

Some aspects include a system, including: one or more processors; and a memory storing instructions that when executed by the processors cause the processor to perform the above-mentioned processes.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates a block diagram of an example policy enforcement system, in accordance with some embodiments of the present disclosure;

FIG. 2 illustrates a block diagram of an example policy enforcement computing device of the policy enforcement system of FIG. 1, in accordance with some embodiments of the present disclosure;

FIG. 3 illustrates a flowchart of an example method for real-time policy enforcement using sequence-aware risk assessment and intervention for third-party software interfaces, in accordance with some embodiments of the present disclosure;

FIG. 4 illustrates a flowchart of an example method for causing a user-interface intervention associated with a proposed action at a third-party software interface, in accordance with some embodiments of the present disclosure;

FIG. 5 illustrates a flowchart of an example method for guided rejection and intervention response for an artificial intelligence agent workflow, in accordance with some embodiments of the present disclosure;

FIG. 6 illustrates a flowchart of an example method for generating policy constraints and linking the generated policy constraints to runtime evaluation of proposed actions, in accordance with some embodiments of the present disclosure;

FIG. 7A illustrates an example first user-interface state associated with a first attached document and a non-intervention outcome at a third-party software interface, in accordance with some embodiments of the present disclosure;

FIG. 7B illustrates an example second user-interface state associated with a second attached document and a controlled send-region state at a third-party software interface, in accordance with some embodiments of the present disclosure;

FIG. 7C illustrates an example third user-interface state associated with the second attached document and a user-interface intervention overlay at a third-party software interface, in accordance with some embodiments of the present disclosure;

FIG. 8 illustrates an example of a computing system that may be implemented by one or more of the devices illustrated in FIGS. 1-2, in accordance with some embodiments of the present disclosure; and

FIG. 9 illustrates an example processing architecture including a latency-sensitive hot path and a parallel background process for evaluating a proposed action and generating policy observations without blocking hot-path decision generation, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the challenges described herein, the inventors had to both invent solutions and, in some cases just as importantly, recognize problems overlooked or not yet foreseen by others in the fields of computer-implemented security systems, interface control systems, third-party software interface monitoring, artificial intelligence and machine learning architectures, generative modeling, and large-scale enterprise policy enforcement systems. The inventors wish to emphasize the difficulty of recognizing those problems that are nascent and will become increasingly apparent in the future should trends in enterprise data volume growth, distributed computing, sequence-aware activity tracking across third-party software interfaces, and the integration of generative and discriminative machine learning models into policy enforcement workflows continue as expected. Because multiple challenges are addressed, it should be understood that some embodiments are field specific, and not all embodiments address every limitation of conventional systems or provide every benefit described herein. That said, improvements that solve various permutations of these challenges are described below.

Existing security and policy enforcement systems frequently evaluate user actions or data-movement events in isolation. In many implementations, conventional data loss prevention systems, endpoint monitoring tools, and application specific controls classify content based on static rules, keywords, regular expressions, or template-based policy definitions and then apply allow or block outcomes at particular transfer points. While such approaches may provide incremental security benefits, they often do not account for the sequence of actions that preceded a proposed action, the context in which the action occurs, or the relationship between actions spanning multiple software interfaces, and therefore may be susceptible to underinclusive detection, overblocking, or failure to detect risky outcomes that emerge only from a broader workflow pattern.

Third-party software interfaces present additional technical challenges. Enterprise users increasingly perform consequential actions through email clients, browsers, messaging applications, collaboration platforms, document tools, customer relationship systems, and other third-party software that was not designed to enforce organization-specific security, compliance, or governance rules. Such software is often distributed as compiled code, executes within isolated process environments, and exposes limited modification hooks. As a result, conventional approaches to influencing behavior at such interfaces frequently rely on vendor cooperation, plug-ins, APIs, or privileged code-injection techniques, which may be unavailable, brittle across software updates, platform-specific, or operationally undesirable in enterprise deployments. As used herein, a “user” may include a human user, an artificial intelligence agent, an artificial intelligence-assisted user, or another actor associated with a monitored workflow unless the context indicates otherwise.

These limitations are further compounded by the fact that operating systems and application frameworks generally do not understand the semantic significance of displayed interface elements or the broader intent associated with a proposed action. A button, menu item, text field, or upload target may be visually present on a screen, but conventional systems typically do not determine whether interacting with that interface element, in view of prior workflow activity, would violate a policy or create a risky outcome. Likewise, existing systems often do not maintain a sequence-aware representation of user or agent behavior across multiple applications or services, and therefore may treat the same proposed action as equivalent in circumstances where the action is routine in one context and highly risky in another.

More recently, artificial intelligence systems, including computer use agents and other autonomous or semi-autonomous artificial intelligence agents, have begun operating third-party software interfaces in place of or alongside human users. In many such deployments, an artificial intelligence agent captures screen content, interprets interface state, and issues clicks, keystrokes, tool calls, or other action requests in furtherance of an assigned task. However, conventional policy enforcement architectures are often not designed to govern both human-performed and agent performed actions through a common control framework. Systems that do attempt to constrain artificial intelligence agents frequently operate only at a model boundary, prompt boundary, or tool call boundary and do not account for what is actually rendered at the interface, what sequence of prior actions occurred across different interfaces, or how to provide structured intervention feedback that allows the agent to adapt, delay, or redirect its behavior.

These limitations are particularly pronounced in enterprise computing environments in which sensitive information, regulated processes, or consequential operational decisions span multiple software interfaces and multiple actors. For example, a file download in a browser may appear benign when viewed in isolation, yet the same file may become risky if subsequently attached to an email, pasted into an artificial intelligence tool, uploaded to an external portal, or operated upon by a computer use agent acting on behalf of a human principal. Conventional systems often lack a unified architecture that observes the relevant interface state, retrieves prior workflow context, evaluates a proposed action against policy constraints using that context, and then causes a targeted intervention at the point of action.

Embodiments of the present disclosure describe a real-time policy enforcement architecture in which action data associated with a proposed action is obtained and converted into structured observations identifying an action type, a context of the proposed action, and one or more interface or system elements associated with the proposed action. Sequence context is retrieved from a data structure storing prior workflow activity, such as an event knowledge graph or other sequence-aware context store, and the proposed action is evaluated against policy constraints using both the structured observations and the sequence context. A risk output is generated, an intervention modality is selected based at least in part on the risk output, and performance of the intervention modality is caused in real-time.

In some embodiments, references herein to policy constraints, policy-violation risk, or policy enforcement should be understood broadly to include other risk criteria, risk conditions, undesired action conditions, governance conditions, fraud-prevention conditions, operational-error conditions, compliance conditions, or other decision criteria used to determine whether a proposed action is risky, undesirable, or requires intervention. Thus, although certain embodiments are described with reference to policies or policy constraints, the disclosed techniques are not limited to enforcement of preexisting written policies and may also be applied using learned risk models, inferred risk criteria, administrative instructions, runtime safety constraints, user-specific guidance, or other action-governance criteria.

In some embodiments, the action data includes screen-state data associated with a graphical user interface, operating system event data, application programming interface data, tool call data, prompt data, response data, or agent action request data. In some embodiments, screen-state data is processed using one or more computer vision models to detect interface elements, application state, visible content, or other contextual indicators associated with a proposed action. In some embodiments, the action data is captured in response to interaction events such as mouse down events, keyboard activity, typing pauses, application transitions, or other event triggers. The disclosed techniques thereby allow the system to operate on real interface state and workflow state, rather than relying solely on static application integrations or post hoc event logs.

In further embodiments, the sequence context is retrieved from an event knowledge graph or other workflow history structure that stores prior actions as nodes linked by temporal relationships, causal relationships, cross application data flow relationships, or combinations thereof. Retrieval may be performed using graph proximity, semantic similarity, temporal recency, or a hybrid retrieval function combining multiple such factors. In some embodiments, the same proposed action receives a different risk output depending on the sequence of prior actions retrieved from the workflow history structure. Thus, a proposed action that is permitted in a first workflow sequence may be identified as risky in a second workflow sequence, even where the visible interface element or nominal action type is otherwise the same.

In some embodiments, the policy constraints are generated by compiling natural language policy specifications into compiled policy constraints before runtime evaluation of proposed actions. In some embodiments, the compiled policy constraints may include distilled or normalized natural language constraints, structured enforcement logic, or combinations thereof suitable for runtime evaluation. The compilation process may include decomposition of policy specifications into scenario classes, detection of contradictions or ambiguities, generation of human-readable previews of enforcement behavior, and explicit approval of such enforcement behavior before deployment. By shifting interpretation of policy text to a pre-deployment compilation phase and applying the compiled policy constraints at runtime, the disclosed architecture improves reproducibility, auditability, and predictability of enforcement outcomes relative to systems that depend on unconstrained runtime interpretation of policy text.

In some embodiments, the intervention modality varies depending on whether the workflow is associated with a human user or an artificial intelligence agent. For human interface workflows, performance of the intervention modality may include causing presentation of a user interface intervention associated with a target interface element corresponding to the proposed action, such as by rendering an operating system-level overlay window above a third-party application, positioning the overlay relative to the target interface element, intercepting input events directed to a covered region, or maintaining spatial alignment as an underlying application window moves, resizes, or scrolls. For artificial intelligence agent workflows, performance of the intervention modality may include causing transmission of a machine-readable intervention response configured to alter, delay, deny, or redirect execution of the proposed action, such as a structured response including a decision field, confidence information, a reason identifying a violated policy constraint, one or more permitted alternative actions, or escalation information.

In some embodiments, such interventions allow a human user to avoid a risky action at the interface and allow an artificial intelligence agent to adapt its behavior without uncontrolled retry behavior or silent failure.

In a specific embodiment, the disclosed system operates in an enterprise environment in which a human user or a computer use artificial intelligence agent interacts with a third-party software interface to perform an email, messaging, upload, download, copy, paste, or data submission action. The system obtains action data associated with the proposed action, processes visible interface state to identify a target interface element, retrieves sequence context associated with prior workflow activity across one or more software interfaces, evaluates the proposed action against policy constraints, and generates a risk output. When the workflow is associated with the human user, the system causes presentation of an overlay, warning, confirmation dialog, or blocking user interface element at or near the target interface element. When the workflow is associated with the artificial intelligence agent, the system causes transmission of a structured intervention response that denies the proposed action, holds the proposed action pending approval, or redirects the artificial intelligence agent toward one or more permitted alternative actions.

Systems and methods of the present disclosure provide several technical improvements to the operation of computer-implemented security and interface control systems. By evaluating proposed actions using both real-time interface derived observations and sequence-aware workflow context, the disclosed architecture improves the ability of computing systems to distinguish between superficially similar actions that carry materially different risk depending on prior workflow state. By causing interventions at third-party software interfaces without requiring modification of the underlying software, the disclosed techniques improve compatibility, reduce dependency on application specific integration points, and enable enforcement across heterogeneous software environments. By integrating deterministic policy compilation, interface state perception, sequence-aware retrieval, and adaptive intervention selection within a unified control framework, the disclosed architecture improves scalability, reproducibility, and technical effectiveness of policy enforcement across distributed enterprise computing environments.

In distributed deployments, the modular separation of action data acquisition, structured observation generation, sequence context retrieval, policy evaluation, and intervention execution enables independent scaling and optimization of system components. As a result, the disclosed system improves throughput and adaptability of real-time policy enforcement workflows, enhances reliability of sequence-aware risk scoring for actions performed at third-party software interfaces, and provides concrete improvements to computer security and interface control functionality suitable for large-scale enterprise environments.

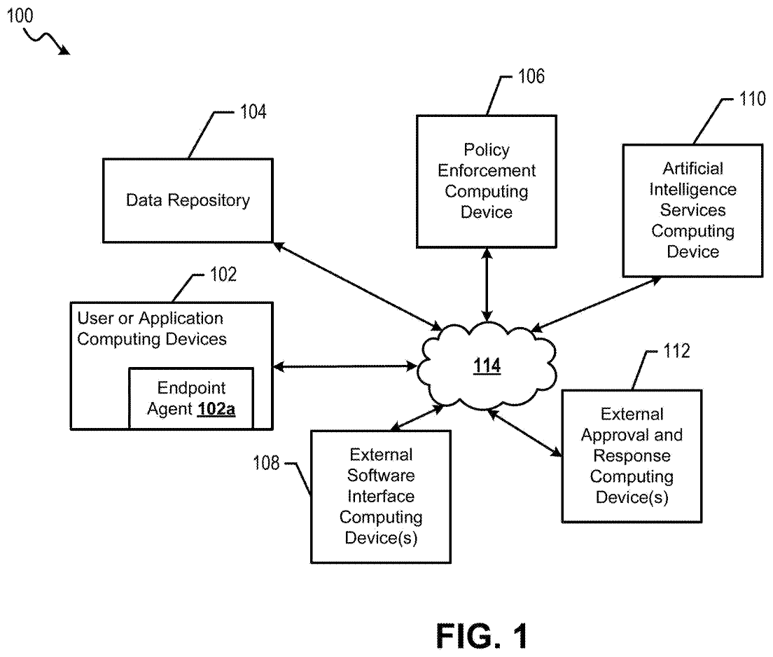

FIG. 1 illustrates an example policy enforcement system 100 suitable for implementing embodiments of the present disclosure. The policy enforcement system 100 may include one or more user or application computing devices 102, a data repository 104, a policy enforcement computing device 106, one or more external software interface computing devices 108, an artificial intelligence services computing device 110, one or more external approval and response computing devices 112, and a network 114 that enables data communication among these components. The configuration shown in FIG. 1 is merely illustrative; other embodiments may include additional, fewer, or alternative components, and functionality described with respect to a single element may, in some implementations, be distributed across multiple physical or virtual computing resources.

In various embodiments, the policy enforcement system 100 may include one or more user or application computing devices 102 that initiate, participate in, or are associated with monitored workflows. The user or application computing devices 102 may represent desktop computing devices, laptop computing devices, mobile devices, enterprise workstations, browser-based clients, locally installed software clients, virtual desktop clients, or other computing devices through which a human user or an artificial intelligence agent performs actions at one or more software interfaces. Each user or application computing device 102 may include one or more processors and a non-transitory memory storing instructions that, when executed, cause the user or application computing device 102 to present software interfaces, receive user inputs, render content associated with third-party software, transmit workflow activity, or communicate status information to other components of the policy enforcement system 100. In some embodiments, the user or application computing devices 102 may interact with the system 100 through secure application programming interfaces, service gateways, message queues, operating system event interfaces, browser communication channels, or other communication mechanisms supporting workflow observation and intervention.

In some embodiments, one or more user or application computing devices 102 may further include or execute a local endpoint agent 102a configured to perform one or more observation, preprocessing, inference, intervention-control, or coordination operations at the device itself. For example, the local endpoint agent 102a may capture screen-state data, collect operating-system event data, detect interface transitions, perform local feature extraction, execute one or more local models, maintain temporary workflow state, render or coordinate a user-interface intervention, or communicate structured emissions to the policy enforcement computing device 106. In some embodiments, the policy enforcement system 100 therefore operates using a hybrid edge-cloud architecture in which one or more latency-sensitive, privacy-sensitive, offline-capable, or cost-sensitive functions are performed locally at the user or application computing device 102 by the local endpoint agent 102a while one or more broader evaluation, compilation, storage, enrichment, or orchestration functions are performed remotely by the policy enforcement computing device 106, the artificial intelligence services computing device 110, or both. In some embodiments, such an arrangement permits continued operation in degraded network conditions, supports offline or intermittently connected workflows, reduces inference latency for certain actions, and enables migration of selected perception or evaluation functions between local and remote execution environments over time.

In some embodiments, some or all of the functionality described herein as being performed by the policy enforcement computing device 106 or the policy enforcement computing device 200 may instead be performed locally, entirely, or in a distributed manner by the local endpoint agent 102a at the user or application computing device 102. For example, acquisition of action data, generation of structured observations, retrieval of sequence context, evaluation of proposed actions, selection of intervention modalities, or causing performance of corresponding interventions may be performed at least in part by the local endpoint agent 102a, either independently or in coordination with one or more remote computing devices. In other embodiments, such functionality may be partitioned between the local endpoint agent 102a and the policy enforcement computing device 106 based on latency requirements, privacy considerations, connectivity conditions, compute availability, cost considerations, or other deployment factors. However, for the sake of brevity and ease of explanation, many embodiments herein are described in the context of operations performed by the policy enforcement computing device 106 or the policy enforcement computing device 200, and such description should not be understood as requiring centralized performance of those operations unless expressly stated otherwise.

In various embodiments, the policy enforcement system 100 may include the policy enforcement computing device 106 configured to coordinate acquisition of action data, generation of structured observations, retrieval of sequence context, evaluation of proposed actions against policy constraints, selection of intervention modalities, and causing performance of corresponding interventions. The policy enforcement computing device 106 may include one or more processors and a non-transitory memory storing instructions that, when executed, cause the policy enforcement computing device 106 to obtain action data indicative of a proposed action within a workflow, generate structured observations identifying an action type, a context of the proposed action, and one or more interface or system elements associated with the proposed action, retrieve sequence context associated with the proposed action from a data structure storing prior workflow activity, evaluate the proposed action against policy constraints using the structured observations and the sequence context to generate a risk output, select an intervention modality based at least in part on the risk output, and cause performance of the intervention modality. In some embodiments, the policy enforcement computing device 106 may further compile natural language policy specifications into policy constraints such as natural language constraint representations or deterministic decision logic, maintain or query an event knowledge graph or other workflow history structure, manage risk scoring and confidence-based intervention selection, and generate or route intervention outputs for human user workflows and artificial intelligence agent workflows. In some implementations, one or more of these functions may be performed by software executing on the policy enforcement computing device 106, while in other implementations such functions may be distributed across multiple computing resources.

In various embodiments, the policy enforcement system 100 may include one or more external software interface computing devices 108 configured to host, serve, support, or otherwise provide third-party software interfaces with which the user or the artificial intelligence agent interacts. The external software interface computing devices 108 may include web application servers, messaging-platform servers, collaboration-system servers, document management servers, customer relationship management servers, issue tracking servers, enterprise portal servers, software-as-a-service platform servers, remote application servers, or other computing systems that provide interface content or interface backed functionality to the user or application computing devices 102. In some embodiments, the external software interface computing devices 108 may expose application programming interfaces, service endpoints, content delivery interfaces, or session interfaces that enable interaction with corresponding software interfaces. In some embodiments, the policy enforcement computing device 106 may observe, evaluate, or intervene with respect to actions associated with such software interfaces without modifying software executing at the external software interface computing devices 108.

In various embodiments, the policy enforcement system 100 may include the artificial intelligence services computing device 110 configured to execute one or more artificial intelligence models, including one or more computer vision models, machine learning risk assessment models, semantic similarity models, retrieval support models, generative models, or other artificial intelligence models supporting operation of the policy enforcement system 100. The artificial intelligence services computing device 110 may receive prompts, screen-state data, structured observations, retrieved workflow context, policy-related inputs, response data, or other information from the policy enforcement computing device 106 and may generate outputs supporting interface element detection, visible content extraction, sequence-aware evaluation, policy compilation, intervention selection, or guided rejection generation. In some embodiments, the artificial intelligence services computing device 110 may be implemented using cloud hosted services, on-premises computing infrastructure, or distributed execution environments. In other embodiments, some or all of the functionality described with respect to the artificial intelligence services computing device 110 may be implemented as a component of the policy enforcement computing device 106.

In various embodiments, the policy enforcement system 100 may include one or more external approval and response computing devices 112 configured to receive, process, present, or act on outputs generated by the policy enforcement computing device 106. The external approval and response computing devices 112 may include approval systems, administrative systems, notification systems, audit systems, workflow systems, case management systems, remediation systems, or other downstream systems configured to receive escalation requests, intervention records, risk outputs, structured rejection responses, approval statuses, or other information generated during policy enforcement. In some embodiments, the external approval and response computing devices 112 may be used when a proposed action is routed for human confirmation, when a human principal is notified regarding an intervention associated with an artificial intelligence agent, or when an intervention outcome is logged or acted upon by a downstream enterprise system. In other embodiments, some or all of the functionality described with respect to the external approval and response computing devices 112 may be incorporated into the policy enforcement computing device 106, and references to the external approval and response computing devices 112 should therefore be understood as encompassing optional externalized implementations of such functions.

In various embodiments, the policy enforcement system 100 may include the data repository 104 configured to store action data, normalized action representations, structured observations, workflow history data, event knowledge graph data, policy specifications, compiled policy logic, intervention templates, intervention history, approval records, notification records, audit logs, or other data supporting operation of the policy enforcement system 100. The data repository 104 may implement access control, indexing, retention policies, graph storage functions, or audit logging functions to support traceability and secure operation of policy enforcement workflows. In some embodiments, the data repository 104 may be shared across the policy enforcement computing device 106, the artificial intelligence services computing device 110, and the external approval and response computing devices 112. In other embodiments, the data repository 104 may include separate repositories associated with respective system components, and references to the data repository 104 should be understood to encompass either arrangement.

In various embodiments, the policy enforcement system 100 may include the network 114, which provides communication among the various computing devices and services. The network 114 may comprise any combination of public or private communication infrastructures, including the Internet, intranets, local area networks, wide area networks, enterprise backbones, or cloud-service backbones. The network 114 may support wired, wireless, or hybrid connectivity and may employ secure communication protocols such as Transport Layer Security (TLS), virtual private network tunneling, message-level encryption, or other cryptographic protections to protect transmitted data.

In operation, the policy enforcement system 100 may obtain, at the policy enforcement computing device 106, action data associated with a proposed action performed through a software interface presented at a user or application computing device 102 and supported by one or more external software interface computing devices 108. The policy enforcement computing device 106 may generate structured observations from the action data, retrieve sequence context associated with the proposed action from prior workflow activity, and evaluate the proposed action against policy constraints to generate a risk output. Based at least in part on the risk output, the policy enforcement computing device 106 may select an intervention modality and cause performance of the intervention modality. In some embodiments, when the workflow is associated with a human user, the intervention modality may include rendering or causing presentation of an interface-based intervention at the user or application computing device 102. In some embodiments, when the workflow is associated with an artificial intelligence agent, the intervention modality may include generation or transmission of a machine-readable response that alters, delays, denies, or redirects execution of the proposed action. One or more outputs of the policy enforcement computing device 106 may be generated with support from the artificial intelligence services computing device 110 and may be stored in the data repository 104 or provided to the external approval and response computing devices 112 for approval handling, notification, auditing, or downstream response actions. Accordingly, the policy enforcement system 100 provides a scalable and modular architecture for real-time policy enforcement, sequence-aware risk assessment, and intervention for third-party software interfaces. While a specific policy enforcement system 100 is illustrated in FIG. 1, one of skill in the art in possession of the present disclosure will recognize that other configurations or policy enforcement systems may fall under the scope of the present disclosure.

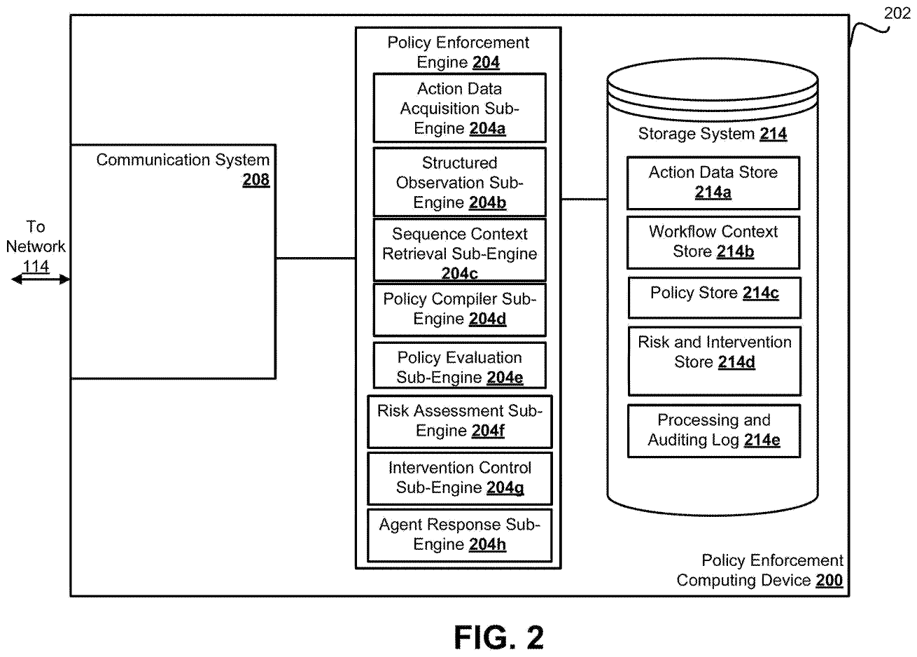

FIG. 2 illustrates an embodiment of a policy enforcement computing device 200 that may be the policy enforcement computing device 106 discussed above with reference to FIG. 1. In the illustrated embodiment, the policy enforcement computing device 200 may include a chassis 202 that houses various components of the device. In various embodiments, the policy enforcement computing device 200 may be implemented using one or more computing platforms, such as servers, cloud-based environments, containerized applications, or virtual machines configured to perform the functionality described herein. In some embodiments, the chassis 202 may house a processing system and a non-transitory memory system that includes instructions which, when executed by the processing system (not illustrated), cause the policy enforcement computing device 200 to provide a policy enforcement engine 204.

The policy enforcement engine 204 may be configured to coordinate acquisition of action data, generation of structured observations, retrieval of sequence context, compilation and application of policy constraints, generation of risk outputs, selection of intervention modalities, and causing performance of corresponding interventions. In various embodiments, the policy enforcement engine 204 may include several sub-engines. An action data acquisition sub-engine 204a may be configured to obtain action data indicative of a proposed action within a workflow. In various embodiments, the action data acquisition sub-engine 204a may obtain screen-state data associated with a graphical user interface, operating system event data, application programming interface data, tool call data, prompt data, response data, agent action request data, or combinations thereof. In some embodiments, the action data acquisition sub-engine 204a may trigger capture of screen-state data or other action data in response to mouse down events, keyboard events, typing pauses, application transitions, or other event triggers.

A structured observation sub-engine 204b may be configured to generate structured observations from the action data. In various embodiments, the structured observation sub-engine 204b may identify an action type, a context of the proposed action, and one or more interface or system elements associated with the proposed action. In some embodiments, the structured observation sub-engine 204b may process captured screen-state data using one or more computer vision models configured to detect target interface elements, visible application state, visible document content, user interface element state, or other interface-related contextual information suitable for downstream processing.

A sequence context retrieval sub-engine 204c may be configured to retrieve sequence context associated with the proposed action from a data structure storing prior workflow activity. In various embodiments, the sequence context retrieval sub-engine 204c may query an event knowledge graph or other workflow history structure that stores prior actions as nodes and stores temporal relationships, causal relationships, cross application data flow relationships, or combinations thereof as links among the nodes. In some embodiments, the sequence context retrieval sub-engine 204c may apply graph-based retrieval, semantic-similarity retrieval, temporal-recency retrieval, or a hybrid retrieval function combining multiple such factors to identify prior actions relevant to evaluation of the proposed action.

In some embodiments, the event knowledge graph or other workflow history structure may store multiple types of nodes and edges corresponding to different aspects of workflow activity. For example, nodes may correspond to actions, documents, applications, destinations, users, artificial intelligence agents, interface elements, or workflow sessions, while edges may correspond to temporal succession, causal dependence, document lineage, actor association, destination relationships, or cross-application transitions. In some embodiments, the sequence context retrieval sub-engine 204c may incrementally update the event knowledge graph as new action data is obtained, may normalize heterogeneous events into canonical node and edge representations, and may maintain identifiers linking graph elements to underlying source records stored in the workflow context store 214b or the data repository 104.

A policy compiler sub-engine 204d may be configured to generate policy constraints used during runtime evaluation of proposed actions. In various embodiments, the policy compiler sub-engine 204d may compile natural language policy specifications into policy constraints such as natural language constraint representations or deterministic decision logic before runtime evaluation of proposed actions. In some embodiments, the policy compiler sub-engine 204d may decompose policy specifications into scenario classes, detect contradictions or ambiguities among scenario classes, generate human-readable previews of enforcement behavior, receive approval of enforcement behavior, and deploy corresponding deterministic decision logic for runtime use.

A policy evaluation sub-engine 204e may be configured to apply policy constraints to the structured observations and the retrieved sequence context. In various embodiments, the policy evaluation sub-engine 204e may retrieve pre-compiled policy constraints from storage and determine whether a proposed action satisfies, violates, or is uncertain with respect to one or more policy constraints. In some embodiments, the policy evaluation sub-engine 204e may generate intermediate policy match outputs, scenario identifiers, or constraint-violation indicators suitable for use by downstream risk-assessment logic.

A risk assessment sub-engine 204f may be configured to evaluate the proposed action using outputs of the policy evaluation sub-engine 204e together with the structured observations and the sequence context and to generate a risk output indicative of whether the proposed action presents a policy violation risk. In various embodiments, the risk assessment sub-engine 204f may generate a risk score, a confidence value, a classification output, or other risk-related indicators. In some embodiments, the risk assessment sub-engine 204f may apply one or more machine learning models configured to process the structured observations and sequence context in a sequence-aware manner such that similar proposed actions may receive different risk outputs when associated with different prior workflow sequences.

An intervention control sub-engine 204g may be configured to select an intervention modality for the proposed action and to cause performance of the intervention modality. In various embodiments, the intervention control sub-engine 204g may apply a confidence-based graduated intervention model in which different intervention modalities are selected for different confidence bands or other ranges of the risk output. In some embodiments, when the workflow is associated with a human user, the intervention control sub-engine 204g may cause presentation of a user interface intervention associated with a target interface element corresponding to the proposed action, such as by rendering an operating system-level overlay window above a third-party application, positioning the overlay window relative to the target interface element, intercepting input events directed to a covered region, or maintaining spatial alignment between the overlay window and the target interface element as an underlying application window moves, resizes, or scrolls.

In some embodiments, the policy enforcement engine 204 may further include an agent response sub-engine 204h configured to support intervention with respect to workflows associated with artificial intelligence agents. The agent response sub-engine 204h may cause transmission of a machine-readable intervention response configured to alter, delay, deny, or redirect execution of a proposed action by an artificial intelligence agent. In various embodiments, the machine-readable intervention response may include a decision field, a confidence field, a reason field identifying a violated policy constraint, an alternatives field identifying one or more permitted alternative actions, an escalation field identifying whether human escalation is available, or other structured response content. In some embodiments, the agent response sub-engine 204h may format the machine-readable intervention response to enable the artificial intelligence agent to programmatically select one of the permitted alternative actions without natural language interpretation.

In some embodiments, the policy enforcement engine 204 may implement a plurality of partially parallel processing paths rather than a strictly sequential pipeline. For example, the policy enforcement engine 204 may implement a latency-sensitive hot path configured to support near-real-time intervention decisions for imminent proposed actions, and may further implement an evidence-enrichment path that operates concurrently, asynchronously, or both to accumulate additional context for later or downstream evaluations. In some embodiments, the hot path may include action-data capture, structured summarization, retrieval of already-available workflow context, risk evaluation, and intervention selection, while the evidence-enrichment path may include subject resolution, policy-observation generation, semantic evidence creation, graph enrichment, artifact association, or other contextualization operations that need not complete before a current intervention decision is made. In such embodiments, the evidence-enrichment path may continue populating the workflow context store 214b or the data repository 104 after a given intervention decision, thereby improving evaluation quality for subsequent proposed actions while preserving responsiveness of the current decision path.

The chassis 202 may also house a communication system 208 that is coupled to the policy enforcement engine 204 via the processing system. The communication system 208 may include hardware, firmware, and software elements that enable the policy enforcement computing device 200 to send and receive data through the network 114. In some embodiments, the communication system 208 may support encrypted communication protocols such as Transport Layer Security (TLS) or Hypertext Transfer Protocol Secure (HTTPS) and may expose authenticated application programming interface endpoints or other communication interfaces through which user or application computing devices 102, external software interface computing devices 108, artificial intelligence services computing device 110, external approval and response computing devices 112, or data repository 104 interact with the policy enforcement computing device 200.

The chassis 202 may also include or be connected to a storage system 214 that is coupled to the policy enforcement engine 204 through the processing system. The storage system 214 may include one or more tangible, non-transitory computer-readable media configured to store data, metadata, and intermediate processing artifacts used during operation of the policy enforcement computing device 200. In some embodiments, the storage system 214 may include an action data store 214a configured to store screen-state data, operating system event data, application programming interface data, tool call data, prompt data, response data, agent action request data, or normalized representations thereof; a workflow context store 214b configured to store workflow history data, event knowledge graph data, or other sequence context data structures; a policy store 214c configured to store policy specifications, compiled policy logic, scenario class data, preview data, or approval data associated with policy compilation and deployment; a risk and intervention store 214d configured to store risk outputs, intervention templates, intervention history, structured agent-response data, approval records, notification records, or other runtime enforcement outputs; and a processing and auditing log 214e configured to store audit logs, processing metadata, model identifiers, retrieval records, policy application records, or other traceability information associated with operation of the policy enforcement computing device 200.

In some embodiments, the storage system 214 may cooperate with the data repository 104 described with reference to FIG. 1, and references to storage systems or data repositories should be understood to encompass local storage within the policy enforcement computing device 200, separate shared repositories, or distributed storage across system components. While the storage system 214 is illustrated as a single component, one of ordinary skill in the art will recognize that the underlying data structures and storage media may be distributed, redundant, or cloud hosted without departing from the scope of the present disclosure. While a specific policy enforcement computing device 200 is illustrated in FIG. 2, one of skill in the art in possession of the present disclosure will recognize that other configurations or policy enforcement computing devices may fall under the scope of the present disclosure.

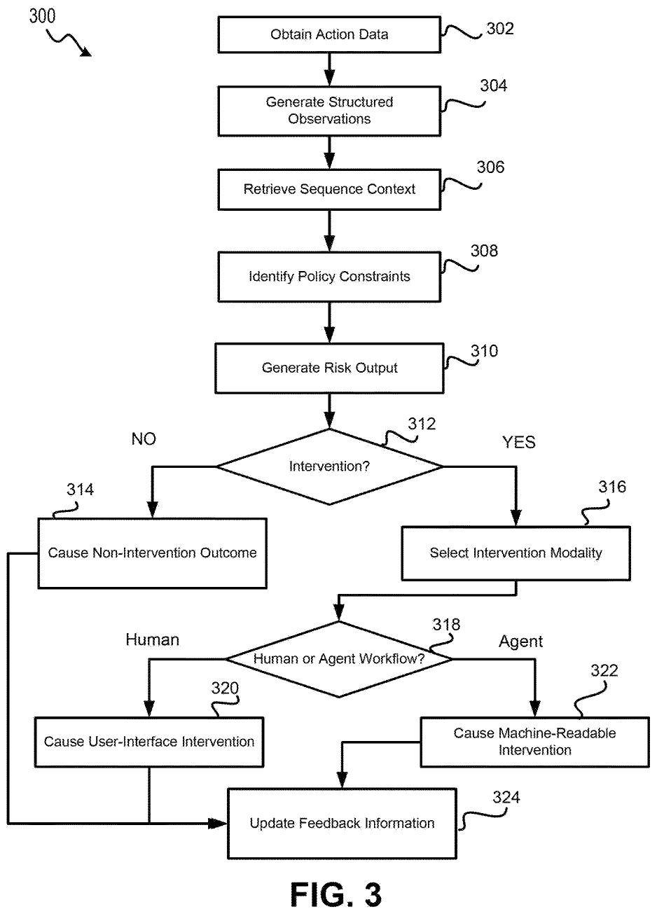

FIG. 3 illustrates an embodiment of a method 300 for real-time policy enforcement using sequence-aware risk assessment and intervention for third-party software interfaces, consistent with some embodiments of the present disclosure. While a particular sequence of operations is illustrated, one of ordinary skill in the art will recognize that certain steps may be omitted, combined, reordered, or supplemented without departing from the scope of the present disclosure. The method 300 provides technological improvements to computer-implemented security and interface control systems by obtaining action data associated with a proposed action, generating structured observations, retrieving sequence context from prior workflow activity, evaluating the proposed action against policy constraints, and causing a selected intervention modality in real time. In some embodiments, one or more of the operations illustrated in method 300 may be executed in parallel, asynchronously, or on partially overlapping timelines, including embodiments in which evidence-enrichment operations continue after a current intervention decision is produced.

The method 300 may begin at block 302 where action data indicative of a proposed action is obtained. In various embodiments, at block 302, the action data acquisition sub-engine 204a of the policy enforcement engine 204 may obtain action data associated with a proposed action within a workflow from one or more user or application computing devices 102, one or more external software interface computing devices 108, or both, via the communication system 208 and the network 114. In various embodiments, the proposed action may correspond to a user input, interface interaction, submission event, upload action, download action, copy action, paste action, send action, tool call, agent action request, or other action associated with interaction at a third-party software interface. The action data may include screen-state data associated with a graphical user interface, operating system event data, application programming interface data, tool call data, prompt data, response data, agent action request data, or combinations thereof.

In some embodiments, the action data acquisition sub-engine 204a may obtain the action data in response to one or more triggers associated with a monitored workflow. For example, the action data acquisition sub-engine 204a may capture screen-state data in response to a mouse down event, keyboard event, typing pause satisfying an idle threshold, application transition, or other event indicating that a proposed action is imminent or underway. In various embodiments, the action data acquisition sub-engine 204a may normalize or structure the obtained action data prior to downstream processing, such as by aligning timestamps, associating the action data with a workflow session identifier, or generating a canonical representation of heterogeneous data obtained from different sources. In some embodiments, the action data and associated session metadata may be stored temporarily within the storage system 214 or the data repository 104 to support traceability, auditing, and consistent workflow state management during subsequent processing steps.

The method 300 may proceed to block 304 where structured observations are generated from the action data. In various embodiments, at block 304, the structured observation sub-engine 204b of the policy enforcement engine 204 may generate structured observations identifying at least an action type, a context of the proposed action, and one or more interface or system elements associated with the proposed action. In various embodiments, the structured observation sub-engine 204b may process the action data to identify a target interface element, application state, visible document content, user interface element state, workflow context indicators, or other information associated with the proposed action.

In some embodiments, generating the structured observations at block 304 includes processing captured screen-state data using one or more computer vision models. For example, the structured observation sub-engine 204b may process screenshots, rendered frames, or other visual interface content to detect interface elements such as buttons, menu items, input fields, upload targets, attachment indicators, dialogue boxes, or other visually presented interface structures associated with the proposed action. In various embodiments, the structured observation sub-engine 204b may combine outputs derived from computer vision processing with outputs derived from operating system event data, application programming interface data, prompt data, response data, or tool call data to generate a structured representation suitable for downstream sequence context retrieval and policy evaluation. In some embodiments, the generated structured observations may be stored together with metadata identifying the originating software interface, application context, timestamps, or model outputs used to generate the structured observations.

The method 300 may proceed to block 306 where sequence context associated with the proposed action is retrieved. In various embodiments, at block 306, the sequence context retrieval sub-engine 204c of the policy enforcement engine 204 may retrieve sequence context associated with the proposed action from a data structure storing prior workflow activity. In various embodiments, the sequence context may include one or more prior actions related to the proposed action across one or more applications or services and may reflect temporal relationships, causal relationships, cross application data flow relationships, or other context linking the proposed action to prior workflow activity.

In some embodiments, the sequence context retrieval sub-engine 204c may retrieve the sequence context by querying an event knowledge graph or other workflow history structure stored in the workflow context store 214b or the data repository 104. For example, the sequence context retrieval sub-engine 204c may identify one or more action nodes corresponding to the current workflow and may traverse or query links representing temporal order, data flow relationships, causal relationships, or contextually similar prior actions to retrieve a set of prior workflow events relevant to evaluation of the proposed action. In various embodiments, retrieval at block 306 may include application of a hybrid retrieval function that combines graph proximity, semantic similarity, and temporal recency to rank prior actions for downstream use. In some embodiments, the retrieved sequence context and associated retrieval metadata may be stored temporarily within the storage system 214 to support reproducibility and auditing of sequence-aware risk assessment operations.

In some embodiments, sequence-aware evaluation may identify a relationship between content observed in different applications even when no explicit file-transfer event, clipboard event, or data-movement application-programming-interface event directly links the applications. For example, the structured observation sub-engine 204b may obtain first screen-state data showing document content, media content, script content, or other source content in a first application and may cause a representation of that content to be stored in the workflow context store 214b or the data repository 104 as part of the retrieved sequence context. Subsequently, the structured observation sub-engine 204b may obtain second content from a second application, such as prompt content, generated content, draft content, image-generation instructions, or other derivative-looking content, and the sequence context retrieval sub-engine 204c or the risk assessment sub-engine 204f may identify semantic similarity, semantic correlation, or other content relationship between the second content and the stored representation of the first content. In some embodiments, such semantic linkage may itself serve as evidence supporting the risk output even in the absence of direct lineage telemetry indicating file upload, copy-and-paste activity, or explicit transfer between the applications. Thus, the disclosed techniques may detect policy-relevant or risk-relevant cross-application continuity across a cognitive boundary at which conventional lineage-based monitoring systems would fail to identify a connection.

The method 300 may proceed to block 308 where policy constraints are identified for evaluation of the proposed action. In various embodiments, at block 308, the policy compiler sub-engine 204d and the policy evaluation sub-engine 204e of the policy enforcement engine 204 may identify policy constraints applicable to the proposed action. In various embodiments, the policy compiler sub-engine 204d may compile natural language policy specifications into compiled policy constraints prior to runtime evaluation, and the policy evaluation sub-engine 204e may retrieve the corresponding compiled policy constraints for use in evaluating the structured observations and the retrieved sequence context. In some embodiments, the compiled policy constraints may include distilled natural-language constraints, structured enforcement logic, or combinations thereof.

In some embodiments, the policy compiler sub-engine 204d may generate the policy constraints through a multi-stage compilation process performed before execution of the runtime evaluation illustrated in method 300. For example, the policy compiler sub-engine 204d may ingest one or more natural language policy specifications, decompose the policy specifications into scenario classes, detect contradictions, overlaps, or ambiguities among the scenario classes, generate human-readable previews of enforcement behavior, receive approval of the enforcement behavior, and deploy deterministic decision logic to the policy store 214c for later retrieval. In various embodiments, the policy evaluation sub-engine 204e may identify one or more scenario classes or rule paths applicable to the proposed action based on the action type, context, interface or system elements, and retrieved sequence context. In some embodiments, the policy evaluation sub-engine 204e may generate one or more intermediate outputs identifying policy matches, policy violations, uncertainty states, or other indicators used by downstream risk-assessment logic.

The method 300 may proceed to block 310 where the proposed action is evaluated to generate a risk output. In various embodiments, at block 310, the risk assessment sub-engine 204f of the policy enforcement engine 204 may evaluate the proposed action against policy constraints using the structured observations and the retrieved sequence context to generate a risk output indicative of whether the proposed action presents a policy violation risk. In various embodiments, the risk output may include a risk score, a confidence value, a classification indicator, a recommended intervention level, or other risk-related indicators suitable for downstream intervention selection.

In some embodiments, the risk assessment sub-engine 204f may apply one or more machine learning models (e.g., via the artificial intelligence services computing device 110) or other evaluation logic configured to perform sequence-aware assessment of the proposed action. For example, the risk assessment sub-engine 204f may process the structured observations, retrieved sequence context, and outputs of the policy evaluation sub-engine 204e to determine whether the proposed action is associated with a policy violation, uncertain policy-compliance state, or acceptable workflow condition. In various embodiments, the same proposed action may receive different risk outputs depending on the retrieved sequence context, such that a first sequence of prior workflow activity produces a first risk output and a second sequence of prior workflow activity produces a second risk output for the same nominal proposed action. In some embodiments, the risk output and associated supporting metadata may be stored within the risk and intervention store 214d or the processing and auditing log 214e for later review, auditing, or downstream policy tuning.

The method 300 may proceed to decision block 312 where a determination is made regarding whether intervention is to be performed. In various embodiments, at decision block 312, the intervention control sub-engine 204g of the policy enforcement engine 204 may determine whether the risk output generated at block 310 satisfies one or more conditions associated with intervention. In various embodiments, the conditions may include one or more thresholds, confidence band conditions, policy states, or other criteria indicating whether a user visible intervention, machine-readable intervention response, logging only outcome, or silent allow outcome is appropriate for the proposed action.

If intervention is not to be performed at decision block 312, the method 300 may proceed to block 314 where a non-intervention outcome is caused. In various embodiments, at block 314, the intervention control sub-engine 204g may allow the proposed action to proceed without a user visible intervention, may record the proposed action and corresponding risk output for auditing purposes, or may otherwise complete evaluation of the proposed action without causing a blocking or warning intervention. In some embodiments, the resulting non-intervention outcome and associated audit data may be stored within the risk and intervention store 214d or the processing and auditing log 214e to support traceability and later policy refinement.

In some embodiments, when the risk output does not satisfy intervention conditions and the proposed action is permitted to proceed, the policy enforcement system 100 may still generate and store a non-intervention audit record. Such a record may include one or more structured observations, retrieved sequence context, one or more risk outputs, a non-intervention indicator, one or more reasons why intervention did not occur, or metadata describing how close the proposed action came to satisfying an intervention threshold. In some embodiments, such non-intervention audit records may support compliance review, tuning of intervention thresholds, identification of near-miss events, enterprise reporting, or later refinement of risk-assessment logic.

If intervention is to be performed at decision block 312, the method 300 may proceed to block 316 where an intervention modality is selected. In various embodiments, at block 316, the intervention control sub-engine 204g may select an intervention modality based at least in part on the risk output. In various embodiments, selecting the intervention modality may include applying a graduated intervention model in which different intervention modalities are selected for different confidence bands or other ranges of the risk output.

In some embodiments, the graduated intervention model applied at block 316 may include multiple intervention levels corresponding to different risk and confidence conditions. For example, at a first confidence band, the intervention control sub-engine 204g may allow the proposed action without user visible intervention or may impose a blocking intervention; at a second confidence band, the intervention control sub-engine 204g may present a non-blocking warning or confirmation dialog; at a third confidence band, the intervention control sub-engine 204g may route the proposed action for human confirmation; and at a fourth confidence band, the intervention control sub-engine 204g may record the proposed action without user visible intervention. In various embodiments, selection of the intervention modality may further depend on whether the workflow is associated with a human user or an artificial intelligence agent. In some embodiments, the selected intervention modality and associated decision metadata may be stored within the risk and intervention store 214d or the processing and auditing log 214e.

In some embodiments, where multiple intervention outcomes are described for a common confidence band, selection among those outcomes may further depend on one or more additional factors including action reversibility, policy severity, destination type, actor type, data sensitivity, or availability of a compliant alternative action. Thus, where a confidence band is associated with either allowing the proposed action without user visible intervention or imposing a blocking intervention, the particular outcome selected within that confidence band may be determined based on such additional factors rather than arbitrarily.

The method 300 may proceed to decision block 318 where a determination is made regarding whether the workflow is associated with a human user or an artificial intelligence agent. In various embodiments, at decision block 318, the intervention control sub-engine 204g and, in some embodiments, the agent response sub-engine 204h may determine whether the selected intervention modality is to be executed through a human interface intervention path or an artificial intelligence agent intervention path. In various embodiments, the determination may be based on workflow metadata, a client type, an action-source indicator, an agent-execution context, or other information associated with the proposed action.

If the workflow is associated with a human user at decision block 318, the method 300 may proceed to block 320 where a user interface intervention is caused. In various embodiments, at block 320, the intervention control sub-engine 204g may cause presentation of a user interface intervention associated with a target interface element corresponding to the proposed action. In various embodiments, the user interface intervention may include rendering an operating system-level overlay window above a third-party application, positioning the overlay window relative to the target interface element, causing presentation of a warning, confirmation dialog, or blocking interface element, or otherwise modifying how the proposed action may be performed through the software interface.

In some embodiments, causing the user interface intervention at block 320 includes intercepting input events directed to a region of a graphical user interface covered by an operating system-level overlay window. For example, the intervention control sub-engine 204g may cause the overlay window to block or delay completion of the proposed action by intercepting mouse inputs, keyboard inputs, or other interaction events directed to the covered region. In various embodiments, the intervention control sub-engine 204g may further cause the overlay window to track movement, resize, or scroll behavior of an application window containing the target interface element so as to maintain spatial alignment between the overlay window and the target interface element. In some embodiments, the resulting intervention state, user interaction with the intervention, and associated interface metadata may be stored within the storage system 214 or data repository 104 for subsequent auditing or policy tuning.

If the workflow is associated with an artificial intelligence agent at decision block 318, the method 300 may proceed to block 322 where a machine-readable intervention response is caused. In various embodiments, at block 322, the agent response sub-engine 204h of the policy enforcement engine 204 may cause transmission of a machine-readable intervention response configured to alter, delay, deny, or redirect execution of the proposed action by the artificial intelligence agent. In various embodiments, the machine-readable intervention response may include a decision field, a confidence field, a reason field identifying a violated policy constraint, an alternatives field identifying one or more permitted alternative actions, an escalation field identifying whether human escalation is available, or other structured response content.

In some embodiments, the agent response sub-engine 204h may format the machine-readable intervention response to enable the artificial intelligence agent to programmatically select one of the permitted alternative actions without natural language interpretation. For example, the machine-readable intervention response may be formatted as a structured data object capable of being parsed by the artificial intelligence agent to identify a deny, hold, modify, or redirect outcome together with one or more permitted alternatives or escalation instructions. In various embodiments, when the selected intervention modality includes escalation or notification, the agent response sub-engine 204h or the intervention control sub-engine 204g may provide corresponding information to one or more external approval and response computing devices 112, such as approval systems, notification systems, workflow systems, or audit systems. In some embodiments, the resulting machine-readable intervention response, downstream notifications, and associated metadata may be stored within the risk and intervention store 214d or the processing and auditing log 214e.

In some embodiments, the method 300 may optionally proceed to block 324 where workflow state and feedback information is updated. In various embodiments, at block 324, the policy enforcement computing device 200 may collect feedback signals associated with risk outputs, selected intervention modalities, intervention outcomes, user interactions with user interface interventions, agent responses to machine-readable intervention responses, approval outcomes, or other runtime enforcement results. In various embodiments, the feedback signals may be used to update one or more parameters associated with sequence context retrieval, policy compilation, policy evaluation, risk assessment, intervention selection, or agent-response generation. For example, the policy enforcement engine 204 may adjust retrieval weights, update scenario class logic, refine confidence thresholds, modify intervention templates, or retrain one or more artificial intelligence models used during structured observation generation, risk assessment, or agent-response generation.

In some embodiments, the policy enforcement computing device 200 may further maintain histories associated with prior proposed actions, prior intervention outcomes, prior approvals, or prior agent responses. Such histories may be used to prevent reuse of stale intervention content, detect repeated policy violation attempts, maintain a sequence-aware understanding of workflow evolution across applications or services, or refine policy enforcement behavior over time. In various embodiments, the feedback information and corresponding updates may be stored within the storage system 214 or data repository 104 together with metadata describing model versions, policy versions, retrieval configurations, and intervention-control parameters to support traceability, reproducibility, and auditability of changes applied to the policy enforcement system 100.

The operations described above with reference to method 300 are provided by way of example and not limitation. Although the method 300 is illustrated as including a particular sequence of operations and decision points, one of ordinary skill in the art will recognize that certain steps may be omitted, combined, reordered, or supplemented without departing from the scope of the present disclosure. In various embodiments, portions of the method 300 may be executed by different computing devices, engines, or services operating in distributed, cloud-based, or hybrid computing environments. Additional embodiments may incorporate alternative computer vision models, policy compilation techniques, sequence-retrieval techniques, risk-assessment models, intervention strategies, or agent-response formats and may be adapted to different software interface environments, workflow contexts, or policy enforcement constraints. Accordingly, the techniques described herein should be understood as illustrative and not limiting, and may be modified, extended, or combined while remaining within the scope of the appended claims.

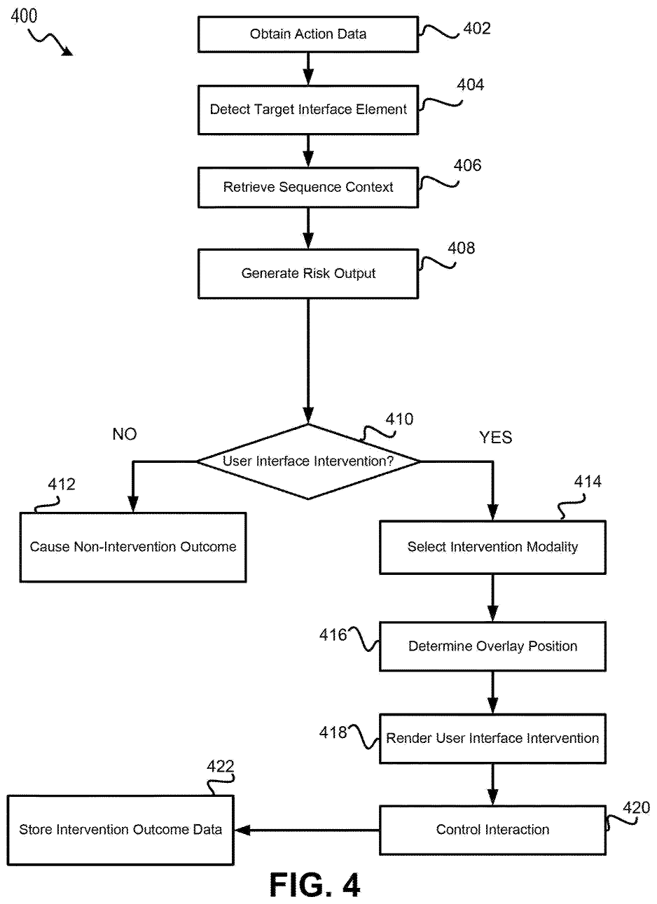

FIG. 4 illustrates an embodiment of a method 400 for causing a user interface intervention associated with a proposed action at a third-party software interface, consistent with some embodiments of the present disclosure. While a particular sequence of operations is illustrated, one of ordinary skill in the art will recognize that certain steps may be omitted, combined, reordered, or supplemented without departing from the scope of the present disclosure. The method 400 provides technological improvements to computer-implemented security and interface control systems by detecting a proposed action at a third-party software interface, evaluating the proposed action in view of sequence-aware workflow context, and causing a targeted user interface intervention associated with a corresponding interface element in real time.

The method 400 may begin at block 402 where action data associated with a proposed action is obtained. In various embodiments, at block 402, the action data acquisition sub-engine 204a of the policy enforcement engine 204 may obtain action data associated with a proposed action performed through a third-party software interface presented at a user or application computing device 102. In various embodiments, the action data may include screen-state data associated with a graphical user interface, operating system event data, application programming interface data, input-event data, or other information indicating that a human user is preparing to interact with an interface element corresponding to the proposed action. In some embodiments, the action data acquisition sub-engine 204a may obtain the action data in response to one or more triggers, such as a mouse down event, a keyboard event, a typing pause satisfying an idle threshold, an application transition, or another event indicating that the proposed action is imminent or underway.

In some embodiments, the obtained action data may correspond to a proposed action including a send action, upload action, download action, paste action, copy action, submit action, share action, or other interface-mediated action performed at a third-party software interface. The action data acquisition sub-engine 204a may associate the obtained action data with one or more workflow identifiers, application identifiers, interface state identifiers, or timestamps suitable for downstream processing. In various embodiments, the obtained action data and associated metadata may be stored temporarily within the action data store 214a, the data repository 104, or both, to support traceability, auditability, and consistent state management during subsequent processing steps illustrated in method 400.

The method 400 may proceed to block 404 where a target interface element associated with the proposed action is detected. In various embodiments, at block 404, the structured observation sub-engine 204b of the policy enforcement engine 204 may process the obtained action data to identify a target interface element corresponding to the proposed action. In various embodiments, the target interface element may include a button, menu item, input region, upload target, attachment control, confirmation control, or other visually presented interface element through which the proposed action is to be completed. In some embodiments, the structured observation sub-engine 204b may process screen-state data using one or more computer vision models configured to detect target interface elements, visible application state, visible document content, user interface element state, or other interface-related contextual information.

In some embodiments, detection of the target interface element at block 404 may include combining outputs derived from computer vision processing with outputs derived from operating system event data, window metadata, interface state indicators, accessibility information, or other contextual signals associated with the third-party software interface. For example, the structured observation sub-engine 204b may determine that a visible button corresponds to a send operation, an upload target corresponds to a file-submission operation, or an interface region corresponds to a paste destination for potentially sensitive information. In various embodiments, the structured observation sub-engine 204b may generate structured observations identifying the action type, interface context, target interface element, and other contextual information suitable for downstream sequence context retrieval and policy evaluation. Such structured observations may be stored together with corresponding model outputs, application metadata, and timestamps within the storage system 214 or the data repository 104.

The method 400 may proceed to block 406 where sequence context associated with the proposed action is retrieved. In various embodiments, at block 406, the sequence context retrieval sub-engine 204c of the policy enforcement engine 204 may retrieve sequence context associated with the proposed action from a data structure storing prior workflow activity. In various embodiments, the retrieved sequence context may include one or more prior actions related to the proposed action across one or more applications or services and may reflect temporal relationships, causal relationships, cross application data flow relationships, or other workflow history information relevant to the proposed action.

In some embodiments, the sequence context retrieval sub-engine 204c may retrieve the sequence context by querying an event knowledge graph or other workflow history structure stored in the workflow context store 214b or the data repository 104. For example, the sequence context retrieval sub-engine 204c may identify one or more prior actions corresponding to a download of a file, access of a regulated record, copying of sensitive text, viewing of a confidential document, or other prior workflow events that bear on the risk associated with the currently proposed action. In various embodiments, retrieval at block 406 may include application of graph-based retrieval, semantic-similarity retrieval, temporal-recency retrieval, or a hybrid retrieval function combining multiple such factors to identify prior actions relevant to downstream policy evaluation and risk assessment. The retrieved sequence context and associated retrieval metadata may be stored temporarily within the storage system 214 to support reproducibility and auditing of sequence-aware intervention operations.

The method 400 may proceed to block 408 where the proposed action is evaluated to generate a risk output. In various embodiments, at block 408, the policy evaluation sub-engine 204e and the risk assessment sub-engine 204f of the policy enforcement engine 204 may evaluate the proposed action against policy constraints using the structured observations and the retrieved sequence context. In various embodiments, the policy evaluation sub-engine 204e may apply pre-compiled deterministic policy logic to identify one or more policy matches, policy violations, uncertainty states, or other intermediate outputs, and the risk assessment sub-engine 204f may generate a risk output indicative of whether the proposed action presents a policy violation risk. The risk output may include a risk score, a confidence value, a classification indicator, a recommended intervention level, or other risk-related indicators suitable for downstream intervention selection.

In some embodiments, the same proposed action may receive different risk outputs depending on the retrieved sequence context. For example, a proposed send action, upload action, or paste action may be associated with a first risk output when the prior workflow sequence is routine and a second risk output when the prior workflow sequence indicates handling of sensitive enterprise information, regulated information, confidential content, or other policy-relevant context. In various embodiments, the risk output and associated supporting metadata may be stored within the risk and intervention store 214d or the processing and auditing log 214e for later review, auditing, or downstream policy tuning.

The method 400 may proceed to decision block 410 where a determination is made regarding whether a user interface intervention is to be performed. In various embodiments, at decision block 410, the intervention control sub-engine 204g of the policy enforcement engine 204 may determine whether the risk output generated at block 408 satisfies one or more conditions associated with causing a user interface intervention. In various embodiments, the conditions may include one or more thresholds, confidence band conditions, policy states, or other criteria indicating whether a warning, confirmation dialog, blocking overlay, or non-intervention outcome is appropriate for the proposed action.

If a user interface intervention is not to be performed at decision block 410, the method 400 may proceed to block 412 where a non-intervention outcome is caused. In various embodiments, at block 412, the intervention control sub-engine 204g may allow the proposed action to proceed without a user visible intervention, may record the proposed action and corresponding risk output for auditing purposes, or may otherwise complete evaluation of the proposed action without causing a blocking or warning interface element. In some embodiments, the resulting non-intervention outcome and associated audit data may be stored within the risk and intervention store 214d or the processing and auditing log 214e to support traceability and later policy refinement.

In some embodiments, when the risk output does not satisfy intervention conditions and the proposed action is permitted to proceed, the policy enforcement system 100 may still generate and store a non-intervention audit record. Such a record may include one or more structured observations, retrieved sequence context, one or more risk outputs, a non-intervention indicator, one or more reasons why intervention did not occur, or metadata describing how close the proposed action came to satisfying an intervention threshold. In some embodiments, such non-intervention audit records may support compliance review, tuning of intervention thresholds, identification of near-miss events, enterprise reporting, or later refinement of risk-assessment logic.

If a user interface intervention is to be performed at decision block 410, the method 400 may proceed to block 414 where an intervention modality is selected. In various embodiments, at block 414, the intervention control sub-engine 204g may select an intervention modality based at least in part on the risk output generated at block 408. In various embodiments, the intervention modality may include a warning overlay, a confirmation interface element, a blocking overlay, an escalation prompt, a guided correction prompt, or another user interface intervention associated with the target interface element. In some embodiments, selection of the intervention modality at block 414 may include applying a confidence-based graduated intervention model in which different intervention modalities are selected for different confidence bands or other ranges of the risk output.

In some embodiments, the intervention control sub-engine 204g may generate one or more intervention parameters associated with the selected intervention modality. For example, the intervention control sub-engine 204g may identify whether the intervention is to block or delay user input, whether the intervention is to present explanatory content describing a policy violation risk, whether one or more selectable response options are to be presented, or whether an approval or escalation path is to be provided. In various embodiments, the selected intervention modality and associated parameters may be stored within the risk and intervention store 214d or the processing and auditing log 214e.

The method 400 may proceed to block 416 where an overlay position associated with the target interface element is determined. In various embodiments, at block 416, the intervention control sub-engine 204g may determine a display position, size, and alignment for an overlay window or other user interface intervention relative to the target interface element identified at block 404. In various embodiments, determination of the overlay position may include calculating coordinates or display regions corresponding to the target interface element, the containing application window, or another relevant region of the graphical user interface. In some embodiments, the intervention control sub-engine 204g may use outputs of the structured observation sub-engine 204b, operating system window metadata, or other interface state information to determine the overlay position.

In some embodiments, the overlay position determined at block 416 may be selected such that the resulting overlay window covers, highlights, obscures, annotates, or otherwise modifies the user's interaction path with respect to the target interface element. For example, the intervention control sub-engine 204g may position the overlay window directly above a send button, upload target, or paste destination so that completion of the proposed action is delayed, guided, or blocked pending user interaction with the overlay. In various embodiments, overlay-position metadata, target-element identifiers, and other placement information may be stored within the storage system 214 or the data repository 104 to support runtime rendering and later auditing of the caused intervention.

The method 400 may proceed to block 418 where the user interface intervention is rendered. In various embodiments, at block 418, the intervention control sub-engine 204g may cause presentation of the selected user interface intervention associated with the target interface element. In various embodiments, causing presentation of the selected user interface intervention may include rendering an operating system-level overlay window above a third-party application and positioning the overlay window relative to the target interface element. The rendered user interface intervention may include warning text, explanatory text, selectable controls, confirmation controls, escalation controls, corrective-action controls, or other interface content configured to affect completion of the proposed action.

In some embodiments, the intervention control sub-engine 204g may cause the user interface intervention to be rendered using platform-specific operating system interfaces or windowing mechanisms. For example, the intervention control sub-engine 204g may render the overlay window using operating system-level window controls, compositing functions, or display layer interfaces that permit the overlay window to be shown above the third-party application without modifying code of the third-party application itself. In various embodiments, the rendered intervention state, presentation timing, and associated interface metadata may be stored within the risk and intervention store 214d or the processing and auditing log 214e.

In some embodiments, the platform-specific rendering and interaction-control techniques may differ across operating systems or interface environments while still implementing a common intervention architecture. For example, the intervention control sub-engine 204g may use different window-management interfaces, compositing layers, accessibility interfaces, display-layer controls, focus-management functions, or input-routing mechanisms depending on whether the user or application computing device 102 executes a first operating system, a second operating system, a browser-based environment, or a remote-session environment. In such embodiments, the policy enforcement engine 204 may provide a common abstraction layer through which target interface detection, overlay positioning, rendering, movement tracking, and input interception are coordinated across heterogeneous platforms.

In some embodiments, the user interface intervention techniques described herein may be performed without modification to an underlying third-party application through which the proposed action is initiated, including embodiments in which the third-party application executes locally at the user or application computing device 102. For example, the intervention control sub-engine 204g may render, position, and manage an operating system-level overlay window and may intercept or control user interaction relative to a target interface element without modifying application code, recompiling the third-party application, or requiring a native plug-in or other application-specific modification to the third-party application.

The method 400 may proceed to block 420 where interaction with the target interface element is controlled. In various embodiments, at block 420, the intervention control sub-engine 204g may cause the rendered user interface intervention to control user interaction associated with the target interface element. In various embodiments, controlling the user interaction may include intercepting input events directed to a region of the graphical user interface covered by the overlay window to block or delay completion of the proposed action, presenting one or more selectable alternatives, or requiring an explicit confirmation or escalation interaction before the proposed action is permitted to continue. In some embodiments, the intervention control sub-engine 204g may selectively pass through or suppress mouse inputs, keyboard inputs, or other interaction events based on the selected intervention modality.

In some embodiments, control of interaction at block 420 may further include maintaining alignment between the rendered user interface intervention and the target interface element as the corresponding application window moves, resizes, scrolls, or otherwise changes state. For example, the intervention control sub-engine 204g may update coordinates, dimensions, or display layer parameters associated with the overlay window so that the overlay window continues to cover or remain associated with the target interface element during user navigation of the third-party software interface. In various embodiments, interaction-control data, movement-tracking data, and resulting user actions may be stored within the storage system 214 or the data repository 104 to support traceability and later policy tuning.

In some embodiments, the method 400 may optionally proceed to block 422 where intervention outcome data is stored and used for subsequent processing. In various embodiments, at block 422, the policy enforcement computing device 200 may store data indicating whether the user accepted the intervention, dismissed the intervention, selected a corrective action, requested escalation, or otherwise interacted with the rendered user interface intervention. In various embodiments, such intervention outcome data may be used to update workflow state, support auditing, provide records to one or more external approval and response computing devices 112, or inform subsequent tuning of sequence context retrieval, policy evaluation, risk-assessment logic, or intervention-selection logic.

The operations described above with reference to method 400 are provided by way of example and not limitation. Although the method 400 is illustrated as including a particular sequence of operations and decision points, one of ordinary skill in the art will recognize that certain steps may be omitted, combined, reordered, or supplemented without departing from the scope of the present disclosure. In various embodiments, portions of the method 400 may be executed by different computing devices, engines, or services operating in distributed, cloud-based, or hybrid computing environments. Additional embodiments may incorporate alternative interface detection techniques, overlay positioning techniques, operating system-level rendering techniques, input-control strategies, or intervention-selection strategies and may be adapted to different software interface environments, policy enforcement contexts, or user-interaction constraints. Accordingly, the techniques described herein should be understood as illustrative and not limiting, and may be modified, extended, or combined while remaining within the scope of the appended claims.

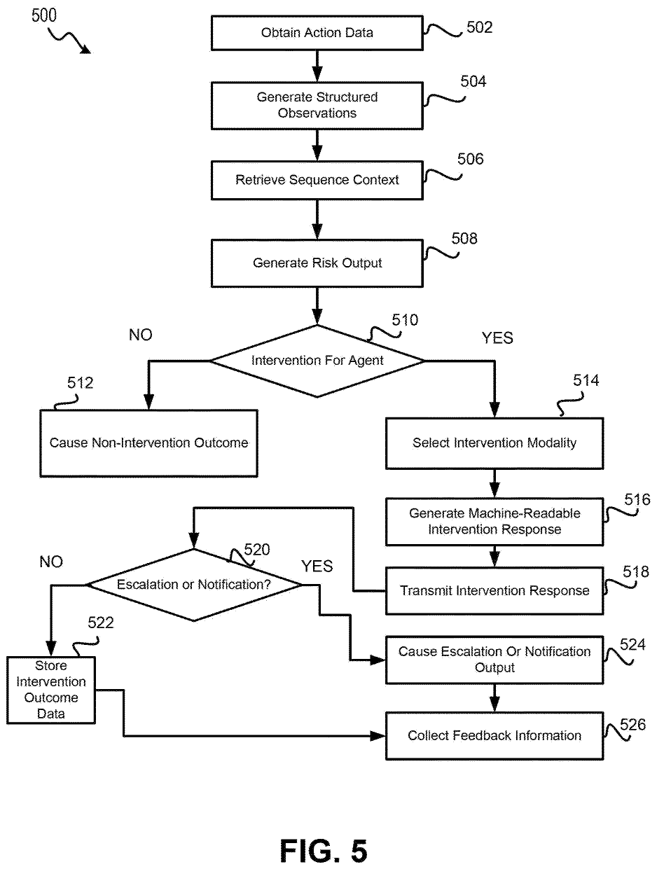

FIG. 5 illustrates an embodiment of a method 500 for guided rejection and intervention response for an artificial intelligence agent workflow, consistent with some embodiments of the present disclosure. While a particular sequence of operations is illustrated, one of ordinary skill in the art will recognize that certain steps may be omitted, combined, reordered, or supplemented without departing from the scope of the present disclosure. The method 500 provides technological improvements to computer-implemented security and workflow-governance systems by evaluating a proposed action associated with an artificial intelligence agent in view of sequence-aware workflow context and causing a machine-readable intervention response that alters, delays, denies, or redirects execution of the proposed action in a structured manner.

The method 500 may begin at block 502 where action data associated with a proposed action by an artificial intelligence agent is obtained. In various embodiments, at block 502, the action data acquisition sub-engine 204a of the policy enforcement engine 204 may obtain action data indicative of a proposed action within a workflow associated with an artificial intelligence agent. In various embodiments, the proposed action may correspond to a tool call, application programming interface request, prompt-driven interface action, click operation, keyboard-input operation, file operation, submission operation, navigation operation, or other action initiated, requested, or prepared by the artificial intelligence agent in connection with a monitored workflow. The action data may include screen-state data, operating system event data, application programming interface data, tool call data, prompt data, response data, agent action request data, or combinations thereof.

In some embodiments, the action data acquisition sub-engine 204a may obtain the action data from one or more user or application computing devices 102, one or more external software interface computing devices 108, one or more artificial intelligence services computing devices 110, or other computing resources associated with execution of the artificial intelligence agent workflow. For example, the action data acquisition sub-engine 204a may obtain a structured action request generated by the artificial intelligence agent, a record of a proposed tool invocation, a prompt-and-response sequence indicating planned execution of an interface action, or screen-state data corresponding to a third-party software interface the artificial intelligence agent is operating. In various embodiments, the obtained action data and corresponding metadata may be associated with a workflow identifier, agent identifier, human-principal identifier, application identifier, or timestamp and may be stored temporarily within the action data store 214a, the data repository 104, or both.

The method 500 may proceed to block 504 where structured observations are generated from the action data. In various embodiments, at block 504, the structured observation sub-engine 204b of the policy enforcement engine 204 may generate structured observations identifying at least an action type, a context of the proposed action, and one or more interface or system elements associated with the proposed action. In various embodiments, the structured observation sub-engine 204b may process the action data to identify the target of the proposed action, the software interface context in which the proposed action is to occur, one or more relevant interface elements or system resources, and other contextual information suitable for downstream sequence context retrieval and policy evaluation.

In some embodiments, generating the structured observations at block 504 may include combining outputs derived from computer vision processing of screen-state data with outputs derived from application programming interface data, tool call data, prompt data, response data, or agent action request data. For example, the structured observation sub-engine 204b may determine that the artificial intelligence agent is preparing to submit content through a browser-based form, invoke a tool that accesses a restricted data source, paste content into an external interface, send an email, upload a document, or perform another action that is subject to one or more policy constraints. In various embodiments, the generated structured observations and associated metadata may be stored within the storage system 214 or the data repository 104 to support later reproducibility and auditing.

The method 500 may proceed to block 506 where sequence context associated with the proposed action is retrieved. In various embodiments, at block 506, the sequence context retrieval sub-engine 204c of the policy enforcement engine 204 may retrieve sequence context associated with the proposed action from a data structure storing prior workflow activity. In various embodiments, the retrieved sequence context may include one or more prior actions related to the proposed action across one or more applications or services and may reflect temporal relationships, causal relationships, cross application data flow relationships, or other workflow history information relevant to the proposed action.

In some embodiments, the sequence context retrieval sub-engine 204c may retrieve the sequence context by querying an event knowledge graph or other workflow history structure stored in the workflow context store 214b or the data repository 104. For example, the sequence context retrieval sub-engine 204c may identify prior actions performed by the artificial intelligence agent, prior actions performed by a human principal associated with the artificial intelligence agent, prior accesses to sensitive content, prior downloads, prior copy operations, prior tool invocations, or other workflow events that bear on the policy significance of the currently proposed action. In various embodiments, retrieval at block 506 may include applying graph-based retrieval, semantic-similarity retrieval, temporal-recency retrieval, or a hybrid retrieval function combining multiple such factors to rank prior actions for downstream use.

In some embodiments, the retrieved sequence context may further include information indicating whether the proposed action aligns with prior workflow activity associated with a human principal of the artificial intelligence agent. For example, the sequence context retrieval sub-engine 204c may retrieve one or more prior actions, intent indicators, approval records, or workflow patterns associated with the human principal and may provide such information for downstream evaluation of whether the artificial intelligence agent is acting within an expected scope or in a manner consistent with prior human-directed workflow behavior. In various embodiments, the retrieved sequence context and associated retrieval metadata may be stored temporarily within the storage system 214 for later auditing and policy refinement operations.

The method 500 may proceed to block 508 where the proposed action is evaluated to generate a risk output. In various embodiments, at block 508, the policy evaluation sub-engine 204e and the risk assessment sub-engine 204f of the policy enforcement engine 204 may evaluate the proposed action against policy constraints using the structured observations and the retrieved sequence context. In various embodiments, the policy evaluation sub-engine 204e may apply pre-compiled deterministic policy logic to identify one or more policy matches, policy violations, uncertainty states, or other intermediate outputs, and the risk assessment sub-engine 204f may generate a risk output indicative of whether the proposed action presents a policy violation risk. The risk output may include a risk score, a confidence value, a classification indicator, a recommended intervention level, or other risk-related indicators suitable for downstream intervention selection.

In some embodiments, the risk assessment sub-engine 204f may determine that the proposed action is associated with a policy violation risk based not only on the nominal action type but also on the sequence of prior workflow actions retrieved at block 506. For example, a tool call, upload action, or message-submission action proposed by the artificial intelligence agent may be associated with a first risk output when prior workflow context is benign and a second risk output when prior workflow context indicates access to sensitive enterprise content, interaction with a restricted system, or divergence from a workflow pattern associated with the human principal. In various embodiments, the generated risk output and corresponding supporting metadata may be stored within the risk and intervention store 214d or the processing and auditing log 214e.

The method 500 may proceed to decision block 510 where a determination is made regarding whether intervention is to be performed for the artificial intelligence agent. In various embodiments, at decision block 510, the intervention control sub-engine 204g and, in some embodiments, the agent response sub-engine 204h of the policy enforcement engine 204 may determine whether the risk output generated at block 508 satisfies one or more conditions associated with causing a machine-readable intervention response. In various embodiments, the conditions may include one or more thresholds, confidence band conditions, policy states, or other criteria indicating whether the proposed action is to be allowed, delayed, denied, redirected, held for approval, or otherwise subject to intervention.

If intervention is not to be performed at decision block 510, the method 500 may proceed to block 512 where a non-intervention outcome is caused. In various embodiments, at block 512, the intervention control sub-engine 204g may allow the proposed action to proceed, may record the proposed action and corresponding risk output for auditing purposes, or may otherwise complete evaluation of the proposed action without causing a machine-readable intervention response that delays, denies, or redirects execution. In some embodiments, the resulting non-intervention outcome and associated metadata may be stored within the risk and intervention store 214d or the processing and auditing log 214e.

In some embodiments, when the risk output does not satisfy intervention conditions and the proposed action is permitted to proceed, the policy enforcement system 100 may still generate and store a non-intervention audit record. Such a record may include one or more structured observations, retrieved sequence context, one or more risk outputs, a non-intervention indicator, one or more reasons why intervention did not occur, or metadata describing how close the proposed action came to satisfying an intervention threshold. In some embodiments, such non-intervention audit records may support compliance review, tuning of intervention thresholds, identification of near-miss events, enterprise reporting, or later refinement of risk-assessment logic.

If intervention is to be performed at decision block 510, the method 500 may proceed to block 514 where an intervention modality is selected. In various embodiments, at block 514, the intervention control sub-engine 204g may select an intervention modality based at least in part on the risk output generated at block 508. In various embodiments, the intervention modality may include a deny action, a hold action, a modify action, a redirect action, a request-for-approval action, an escalation action, or another machine-readable intervention suitable for an artificial intelligence agent workflow. In some embodiments, selection of the intervention modality may include applying a confidence-based graduated intervention model in which different intervention modalities are selected for different confidence bands or other ranges of the risk output.

In some embodiments, the selected intervention modality may depend on whether the proposed action is assessed as definitely risky, likely risky, uncertain, or unable to be reliably classified. For example, the intervention control sub-engine 204g may select a deny outcome for a proposed action associated with a high-confidence policy violation, may select a hold or escalation outcome for a proposed action associated with uncertainty, or may select a redirect outcome that guides the artificial intelligence agent toward one or more permitted alternative actions. In various embodiments, the selected intervention modality and associated decision metadata may be stored within the risk and intervention store 214d or the processing and auditing log 214e.

The method 500 may proceed to block 516 where a machine-readable intervention response is generated. In various embodiments, at block 516, the agent response sub-engine 204h of the policy enforcement engine 204 may generate a machine-readable intervention response configured to alter, delay, deny, or redirect execution of the proposed action by the artificial intelligence agent. In various embodiments, the machine-readable intervention response may include a decision field, a confidence field, a reason field identifying a violated policy constraint, an alternatives field identifying one or more permitted alternative actions, an escalation field identifying whether human escalation is available, or other structured response content suitable for controlling agent execution.

In some embodiments, generation of the machine-readable intervention response at block 516 may include constructing a structured data object that enables the artificial intelligence agent to parse the intervention response without natural language interpretation. For example, the agent response sub-engine 204h may generate a structured response indicating a deny outcome together with one or more permitted alternatives, a hold outcome together with approval routing information, or a redirect outcome together with an allowed action path. In various embodiments, the machine-readable intervention response may further include one or more identifiers corresponding to the relevant policy constraint, scenario class, workflow state, escalation record, audit record, or approval record associated with the proposed action. In some embodiments, the generated machine-readable intervention response and associated metadata may be stored within the risk and intervention store 214d or the processing and auditing log 214e.

The method 500 may proceed to block 518 where the machine-readable intervention response is transmitted. In various embodiments, at block 518, the agent response sub-engine 204h may cause transmission of the machine-readable intervention response to one or more computing resources associated with the artificial intelligence agent workflow. In various embodiments, the machine-readable intervention response may be transmitted to a runtime component of the artificial intelligence agent, a tool-execution environment, an application programming interface layer, a workflow orchestrator, a proxy service, or another computing component capable of altering, delaying, denying, or redirecting execution of the proposed action in response to the machine-readable intervention response.

In some embodiments, transmission at block 518 may cause the artificial intelligence agent to programmatically select one of the permitted alternative actions identified in the machine-readable intervention response. For example, the artificial intelligence agent may parse the decision field, reason field, alternatives field, and escalation field and may responsively select an allowed alternative, request approval, or terminate execution of the proposed action. In various embodiments, the resulting transmission record, corresponding delivery metadata, and resulting execution-state information may be stored within the storage system 214 or the data repository 104 to support traceability and later evaluation of intervention effectiveness.

In some embodiments, intervention with respect to an artificial intelligence agent may additionally or alternatively be performed through operating-system-level interception of simulated input events associated with the artificial intelligence agent. For example, the intervention control sub-engine 204g may intercept, suppress, delay, modify, or redirect simulated mouse events, keyboard events, click events, drag events, or other operating-system-level input events generated on behalf of the artificial intelligence agent before those events reach a target application or corresponding target interface element. In some embodiments, such operating-system-level intervention may be performed without requiring cooperation from the runtime environment of the artificial intelligence agent and without requiring the artificial intelligence agent to honor a machine-readable deny or redirect response. In this manner, the disclosed system may support both cooperative intervention through machine-readable responses and non-cooperative intervention through operating-system-level control of agent-executed interface actions.

The method 500 may proceed to decision block 520 where a determination is made regarding whether escalation or notification is to be performed. In various embodiments, at decision block 520, the intervention control sub-engine 204g or the agent response sub-engine 204h may determine whether the selected intervention modality or the generated machine-readable intervention response includes an escalation condition, an approval condition, or a notification condition. In various embodiments, the escalation or notification condition may indicate that one or more external approval and response computing devices 112 are to receive information corresponding to the proposed action, the intervention response, or a related approval request.

If escalation or notification is not to be performed at decision block 520, the method 500 may proceed to block 522 where intervention outcome data is stored. In various embodiments, at block 522, the policy enforcement computing device 200 may store data indicating the selected intervention modality, the generated machine-readable intervention response, the resulting artificial intelligence agent action state, or other intervention outcome data within the risk and intervention store 214d or the processing and auditing log 214e.

If escalation or notification is to be performed at decision block 520, the method 500 may proceed to block 524 where escalation or notification output is caused. In various embodiments, at block 524, the intervention control sub-engine 204g or the agent response sub-engine 204h may provide one or more outputs to one or more external approval and response computing devices 112, such as approval systems, notification systems, workflow systems, case management systems, or audit systems. In various embodiments, the output may include an approval request, a notification to a human principal associated with the artificial intelligence agent, a structured intervention record, a hold record, or another downstream action-triggering record associated with the proposed action and corresponding machine-readable intervention response.

In some embodiments, evaluation of the proposed action by the artificial intelligence agent may further include evaluating the proposed action using data indicating prior actions, prior approvals, prior preferences, or prior workflow patterns associated with a human principal of the artificial intelligence agent. In some embodiments, when an intervention modality delays, denies, redirects, or escalates execution of the proposed action, the intervention control sub-engine 204g or the agent response sub-engine 204h may cause notification of the human principal, may request confirmation from the human principal, or may route the proposed action to the human principal for approval before further execution is permitted.

In some embodiments, the notification or escalation output caused at block 524 may indicate that a proposed action was delayed, denied, redirected, or held for approval and may identify the reason for the intervention together with one or more policy identifiers, workflow state indicators, or approval routing instructions. In various embodiments, the resulting escalation data, approval outcomes, notification records, and related metadata may be stored within the storage system 214 or the data repository 104 for later auditing, policy tuning, or workflow history maintenance.

In some embodiments, the method 500 may optionally proceed to block 526 where feedback information associated with the intervention is collected. In various embodiments, at block 526, the policy enforcement computing device 200 may collect feedback signals indicating whether the artificial intelligence agent accepted a permitted alternative action, retried a denied action, requested approval, terminated execution, or otherwise responded to the machine-readable intervention response. In various embodiments, such feedback information may be used to update workflow state, maintain histories associated with prior artificial intelligence agent interventions, refine intervention templates, adjust escalation rules, or tune one or more models or policy thresholds used during sequence context retrieval, risk assessment, intervention selection, or agent-response generation.

The operations described above with reference to method 500 are provided by way of example and not limitation. Although the method 500 is illustrated as including a particular sequence of operations and decision points, one of ordinary skill in the art will recognize that certain steps may be omitted, combined, reordered, or supplemented without departing from the scope of the present disclosure. In various embodiments, portions of the method 500 may be executed by different computing devices, engines, or services operating in distributed, cloud-based, or hybrid computing environments. Additional embodiments may incorporate alternative artificial intelligence agent execution models, alternative machine-readable response formats, alternative escalation workflows, alternative policy-evaluation techniques, or alternative sequence-retrieval strategies and may be adapted to different workflow-governance environments, software interface contexts, or artificial intelligence agent control constraints. Accordingly, the techniques described herein should be understood as illustrative and not limiting, and may be modified, extended, or combined while remaining within the scope of the appended claims.

In some embodiments, the human user intervention techniques described with reference to method 400 of FIG. 4 and the artificial intelligence agent intervention techniques described with reference to method 500 of FIG. 5 are implemented as different intervention branches of a common policy enforcement architecture. In various embodiments, the same policy enforcement computing device 200 may obtain action data, generate structured observations, retrieve sequence context, evaluate proposed actions against policy constraints, and generate risk outputs for both human user workflows and artificial intelligence agent workflows. The resulting intervention modality may differ depending on whether the proposed action is associated with a human user, an artificial intelligence agent, or a workflow that includes both human user activity and artificial intelligence agent activity.

In some embodiments, a single workflow may include transitions between human-performed actions and artificial intelligence agent performed actions. For example, a human user may initiate a workflow at a third-party software interface, provide instructions to an artificial intelligence agent, review output generated by the artificial intelligence agent, and then perform a subsequent interface action based on the generated output. In other embodiments, an artificial intelligence agent may initiate or prepare one or more actions, after which a human user may review, confirm, modify, or complete one or more of those actions through a user interface. In such embodiments, prior actions performed by the human user may be included in the sequence context used to evaluate a proposed action by the artificial intelligence agent, and prior actions performed by the artificial intelligence agent may be included in the sequence context used to evaluate a proposed action by the human user.

In various embodiments, an intervention caused in one branch may affect operation of the other branch. For example, a machine-readable intervention response generated for an artificial intelligence agent may cause the artificial intelligence agent to suspend execution and request approval from a human user, after which a user interface intervention may be rendered to the human user to present the reason for the suspension, one or more permitted alternatives, or one or more approval options. Conversely, a user interface intervention presented to a human user may result in input that changes how an artificial intelligence agent proceeds, such as by supplying approval, selecting an alternative action, modifying a workflow objective, or denying continuation of an agent-initiated task. In some embodiments, outputs associated with such cross-branch interactions may be stored as part of a common workflow history so that subsequent policy evaluation remains sequence-aware across both human user and artificial intelligence agent phases of the workflow.

In some embodiments, the common policy enforcement architecture may apply shared policy constraints, shared workflow history structures, shared risk-assessment logic, and shared intervention-selection logic across both human user workflows and artificial intelligence agent workflows while still supporting different runtime intervention mechanisms for the two workflow types. For example, the same policy constraint and sequence-aware risk logic may identify a policy violation risk for a proposed action regardless of whether the action is to be completed through a human-operated interface element or through an artificial intelligence agent action request, while the resulting intervention differs in form as between an overlay-based or other user interface intervention and a machine-readable intervention response. By supporting such unified yet differentiated operation, the disclosed system enables consistent policy enforcement across workflows that are fully human-driven, fully agent-driven, or shared between human users and artificial intelligence agents.

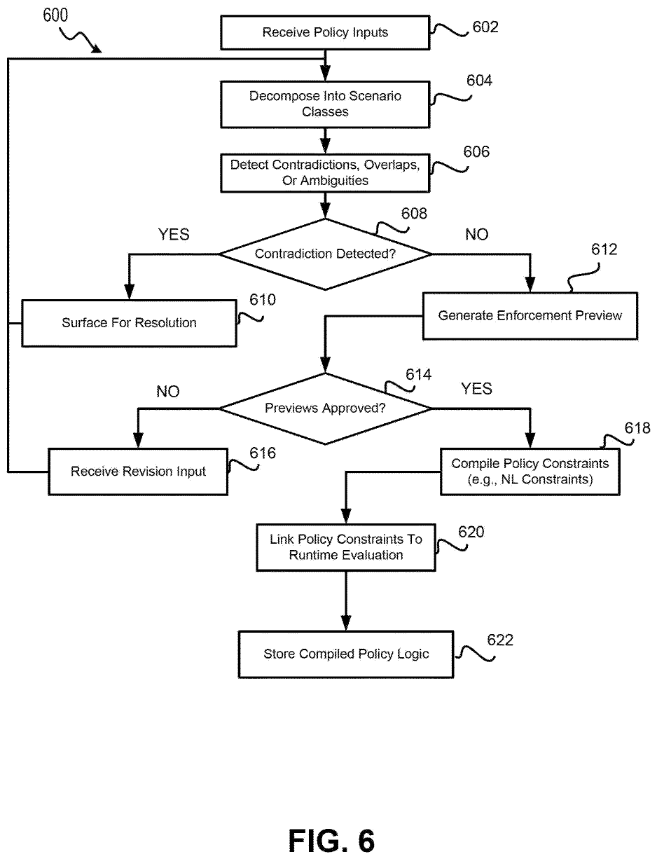

FIG. 6 illustrates an embodiment of a method 600 for generating policy constraints and linking the generated policy constraints to runtime evaluation of proposed actions, consistent with some embodiments of the present disclosure. While a particular sequence of operations is illustrated, one of ordinary skill in the art will recognize that certain steps may be omitted, combined, reordered, or supplemented without departing from the scope of the present disclosure. The method 600 provides technological improvements to computer-implemented policy enforcement systems by transforming policy inputs into policy constraints such as natural language deterministic decision logic that may be applied during runtime sequence-aware evaluation of proposed actions, thereby reducing dependence on unconstrained runtime interpretation of policy text.

The method 600 may begin at block 602 where one or more policy inputs are received. In various embodiments, at block 602, the policy compiler sub-engine 204d of the policy enforcement engine 204 may receive one or more policy inputs from the data repository 104, one or more external approval and response computing devices 112, or other policy management sources via the communication system 208 and the network 114. In various embodiments, the policy inputs may include natural language policy specifications, compliance requirements, regulatory directives, administrative instructions, legacy rule sets, or other policy-related content defining conditions under which actions performed at third-party software interfaces are to be allowed, warned upon, delayed, redirected, escalated, or blocked. In some embodiments, the received policy inputs may be associated with policy identifiers, version metadata, source identifiers, timestamps, approval state indicators, or deployment scope metadata suitable for downstream compilation and auditing operations.

In some embodiments, the policy compiler sub-engine 204d may parse or normalize the received policy inputs prior to subsequent processing. For example, the policy compiler sub-engine 204d may convert heterogeneous policy documents into a canonical internal representation, align terminology across multiple policy inputs, extract relevant policy statements, or associate policy statements with one or more categories of workflow activity, interface interactions, actor types, destination types, or data sensitivity conditions. In various embodiments, the received policy inputs and corresponding normalized representations may be stored temporarily within the policy store 214c or the data repository 104 to support traceability, reproducibility, and later auditing of policy compilation operations.

The method 600 may proceed to block 604 where the policy inputs are decomposed into scenario classes. In various embodiments, at block 604, the policy compiler sub-engine 204d may decompose the received policy inputs into a plurality of scenario classes suitable for downstream evaluation and compilation. In various embodiments, each scenario class may include an action type, a context specification, and a sequence pattern associated with one or more proposed actions that may occur within a monitored workflow. For example, a scenario class may correspond to an upload action, send action, paste action, tool call action, download action, or another action type performed in combination with one or more contextual conditions and one or more patterns of prior workflow activity.

In some embodiments, decomposition at block 604 may include identifying implicit sub-scenarios within broadly stated policy text. For example, the policy compiler sub-engine 204d may process a policy specification directed to restricted external sharing of enterprise information and may decompose the policy specification into multiple scenario classes corresponding to different interface actions, software interface contexts, actor types, destination types, or workflow sequence conditions. In various embodiments, the policy compiler sub-engine 204d may generate structured scenario representations that identify action-level conditions, context-level conditions, sequence-level conditions, and preliminary enforcement outcomes associated with each scenario class. Such structured scenario representations may be stored within the policy store 214c or the data repository 104 for later use during conflict detection, preview generation, and compilation.

The method 600 may proceed to block 606 where contradictions, overlaps, or ambiguities among scenario classes are detected. In various embodiments, at block 606, the policy compiler sub-engine 204d may analyze the plurality of scenario classes generated at block 604 to identify contradictions, overlaps, ambiguities, or other inconsistency conditions. In various embodiments, contradictions may include multiple scenario classes that prescribe different enforcement outcomes for the same or materially similar conditions, overlaps may include multiple scenario classes that apply simultaneously to a common action or context pattern, and ambiguities may include underspecified or conflicting language that prevents reliable generation of deterministic runtime logic.

In some embodiments, the policy compiler sub-engine 204d may identify contradiction or ambiguity conditions by comparing action types, context specifications, sequence patterns, destination categories, actor categories, or other attributes associated with the scenario classes. For example, the policy compiler sub-engine 204d may determine that a first scenario class directs a blocking outcome for a proposed action while a second scenario class directs a warning or allow outcome for the same or similar conditions. In various embodiments, the policy compiler sub-engine 204d may generate conflict records, overlap records, ambiguity indicators, or other structured outputs identifying affected scenario classes and associated resolution information. Such records may be stored in the policy store 214c or the processing and auditing log 214e to support downstream review and approval operations.

The method 600 may proceed to decision block 608 where a determination is made regarding whether contradictions, overlaps, or ambiguities were detected. In various embodiments, at decision block 608, the policy compiler sub-engine 204d may determine whether one or more contradiction conditions, overlap conditions, or ambiguity conditions identified at block 606 satisfy one or more resolution criteria. In various embodiments, the resolution criteria may include whether the detected condition requires human review, whether one scenario class takes precedence over another based on predefined ordering logic, or whether one or more scenario classes are to be modified prior to preview generation.

If contradictions, overlaps, or ambiguities are detected at decision block 608, the method 600 may proceed to block 610 where the detected conditions are surfaced for resolution. In various embodiments, at block 610, the policy compiler sub-engine 204d may generate one or more resolution records, alerts, review items, or other outputs identifying the affected scenario classes and may provide corresponding outputs to one or more external approval and response computing devices 112, administrative systems, or other policy management interfaces for review. In various embodiments, the surfaced information may identify conflicting action outcomes, overlapping scenario conditions, ambiguous terms, proposed resolutions, or other information suitable for human resolution. In some embodiments, after receiving corresponding resolution input, the method 600 may return to block 604 or block 606 to continue decomposition and conflict analysis using revised policy information.

If contradictions, overlaps, or ambiguities are not detected at decision block 608, or after such conditions are resolved, the method 600 may proceed to block 612 where one or more human-readable enforcement previews are generated. In various embodiments, at block 612, the policy compiler sub-engine 204d may generate one or more human-readable previews of enforcement behavior corresponding to one or more scenario classes. In various embodiments, each human-readable preview may describe how the policy enforcement system 100 will respond when a corresponding action type, context specification, and sequence pattern are encountered during a monitored workflow. For example, a human-readable preview may specify that, for a given scenario class, a proposed action will be allowed, warned upon, delayed, redirected, routed for approval, or blocked.

In some embodiments, generation of the human-readable previews at block 612 may include converting structured scenario representations into approval-ready preview content for use by an administrator, policy approver, or other reviewer. In various embodiments, the preview content may include scenario identifiers, descriptive text, affected action types, context conditions, sequence conditions, proposed intervention modalities, confidence-related conditions, escalation rules, or other information suitable for validating expected runtime behavior before deployment. In some embodiments, the human-readable previews and associated metadata may be stored within the policy store 214c or the data repository 104 for use during subsequent approval and compilation operations.

The method 600 may proceed to decision block 614 where a determination is made regarding whether the human-readable enforcement previews are approved. In various embodiments, at decision block 614, the policy compiler sub-engine 204d or one or more external approval and response computing devices 112 may determine whether the human-readable previews generated at block 612 satisfy one or more approval conditions associated with deployment of deterministic runtime logic. In various embodiments, the approval conditions may include explicit administrator approval, approval by one or more designated approvers, or other review-state conditions indicating that the corresponding enforcement behavior is authorized for compilation and deployment.

If the human-readable enforcement previews are not approved at decision block 614, the method 600 may proceed to block 616 where revision input is received. In various embodiments, at block 616, the policy compiler sub-engine 204d may receive modification input, revised policy text, revised scenario definitions, modified approval parameters, or other feedback indicating how the human-readable previews or underlying scenario classes are to be changed. In various embodiments, the policy compiler sub-engine 204d may update one or more scenario classes, policy attributes, or preview records based on the revision input and may return to block 604, block 606, or block 612 to continue policy compilation processing using the revised information. In some embodiments, revision records and corresponding review metadata may be stored within the policy store 214c or the processing and auditing log 214e.

If the human-readable enforcement previews are approved at decision block 614, the method 600 may proceed to block 618 where policy constraints are compiled. In various embodiments, at block 618, the policy compiler sub-engine 204d may compile the approved scenario classes and corresponding enforcement behavior into policy constraints suitable for runtime use by the policy evaluation sub-engine 204e. In various embodiments, the compiled policy constraints may include structured rule paths, decision trees, scenario identifiers, policy match criteria, intervention-selection criteria, escalation conditions, confidence thresholds, or other machine-usable logic for evaluating proposed actions at runtime. In some embodiments, the policy compiler sub-engine 204d may generate hashes, version identifiers, or integrity metadata associated with the compiled policy constraints to support controlled deployment and later auditing. In some embodiments, the policy constraints may include compiled natural language constraints, deterministic decision logic, or other structure.

In some embodiments, the inventors of the present disclosure recognized that reducing policy inputs exclusively to rigid binary rules or fully deterministic decision trees may omit semantic nuance that is relevant to evaluation of real-world workflows, particularly where proposed actions are assessed using sequence context spanning multiple applications, devices, actors, or partial evidentiary signals. For example, a policy input may distinguish between actions that are clearly prohibited, actions that are conditionally permissible, actions requiring escalation, and actions whose risk significance depends on contextual relationships that are not efficiently captured by fixed rule reduction alone. Accordingly, in some embodiments, the policy compiler sub-engine 204d may generate compiled policy constraints that remain in natural language form, such as distilled, normalized, minimized, or otherwise transformed natural language constraints suitable for runtime application. In such embodiments, the compiled natural language constraints may preserve semantic context, conditional nuance, actor-specific distinctions, escalation guidance, exception structure, or other evaluative meaning from the source policy inputs while still being approval-gated, versioned, linked to scenario classes, and deployable for runtime evaluation without requiring unconstrained reinterpretation of the original source policy text at each evaluation event.

In some embodiments, the compiled deterministic decision logic may be represented as one or more machine-usable structures including rule graphs, decision trees, scenario tables, executable policy objects, or other structured runtime artifacts that map combinations of action types, context specifications, sequence patterns, and intervention conditions to corresponding enforcement outcomes. In some embodiments, such runtime artifacts may include identifiers linking compiled logic back to source policy inputs, scenario classes, preview records, or approval records, thereby supporting traceability between natural language policy inputs and runtime policy application.

In some embodiments, compiling at block 618 may be performed in a manner that avoids runtime dependence on unconstrained natural language interpretation. For example, the policy compiler sub-engine 204d may convert approved scenario classes into structured rule paths executable by the policy evaluation sub-engine 204e during real-time assessment of proposed actions, such that the runtime evaluation performed by the policy enforcement computing device 200 applies pre-compiled policy constraints rather than reinterpreting natural language policy text during each monitored workflow event. In various embodiments, the compiled policy constraints may be stored within the policy store 214c together with corresponding scenario class metadata, preview records, approval records, and version metadata.

The method 600 may proceed to block 620 where compiled policy constraints are linked to runtime evaluation of proposed actions. In various embodiments, at block 620, the policy compiler sub-engine 204d may deploy or otherwise make available the compiled policy constraints to one or more runtime enforcement components of the policy enforcement engine 204, such as the policy evaluation sub-engine 204e, the risk assessment sub-engine 204f, the intervention control sub-engine 204g, or the agent response sub-engine 204h. In various embodiments, block 620 may correspond to the policy-identification operations described with reference to block 308 of FIG. 3, in which policy constraints applicable to a proposed action are identified for runtime evaluation. For example, the policy evaluation sub-engine 204e may retrieve one or more scenario classes, rule paths, or other compiled policy constraints generated by method 600 for application to structured observations and retrieved sequence context during execution of block 308 of FIG. 3.

In some embodiments, the compiled policy constraints made available at block 620 may also correspond to the runtime evaluation operations described with reference to block 310 of FIG. 3. For example, the policy evaluation sub-engine 204e may apply the compiled policy constraints to determine whether a proposed action satisfies, violates, or is uncertain with respect to one or more policy constraints, and the risk assessment sub-engine 204f may use outputs of such policy evaluation together with the structured observations and retrieved sequence context to generate the risk output described with reference to block 310 of FIG. 3. In various embodiments, deployment or linking at block 620 may include activating a new policy version, replacing a prior policy version, associating the compiled logic with one or more scope conditions, or otherwise making the compiled policy constraints available for runtime use during sequence-aware policy enforcement.

The method 600 may proceed to block 622 where compiled policy logic and associated metadata are stored. In various embodiments, at block 622, the policy compiler sub-engine 204d may store the compiled deterministic decision logic together with approval records, preview records, scenario class records, conflict-resolution records, deployment records, hashes, timestamps, version metadata, or other policy compilation artifacts within the policy store 214c, the data repository 104, or both. In various embodiments, the stored information may support auditability, traceability, rollback operations, reproducibility of enforcement behavior, or later policy refinement operations. In some embodiments, storage at block 622 may include associating the compiled policy logic with one or more identifiers suitable for later retrieval by the policy evaluation sub-engine 204e during runtime evaluation of proposed actions.

In some embodiments, the policy compiler sub-engine 204d may perform adaptive feedback operations based on runtime outcomes observed after deployment of compiled policy constraints. For example, the policy compiler sub-engine 204d may receive data indicating intervention outcomes, approval outcomes, false-positive conditions, false-negative conditions, repeated revision patterns, or other signals associated with operation of the deployed deterministic decision logic and may use such information to prompt subsequent recompilation, adjustment of scenario definitions, revision of preview content, or refinement of approval conditions. In various embodiments, such feedback information may be stored together with policy compilation metadata to support later policy updates and controlled evolution of runtime enforcement behavior.

The operations described above with reference to method 600 are provided by way of example and not limitation. Although the method 600 is illustrated as including a particular sequence of operations and decision points, one of ordinary skill in the art will recognize that certain steps may be omitted, combined, reordered, or supplemented without departing from the scope of the present disclosure. In various embodiments, portions of the method 600 may be executed by different computing devices, engines, or services operating in distributed, cloud-based, or hybrid computing environments. Additional embodiments may incorporate alternative policy-parsing techniques, scenario-generation techniques, conflict-resolution workflows, preview-generation strategies, compilation strategies, deployment mechanisms, or approval workflows and may be adapted to different policy domains, enterprise environments, or runtime enforcement constraints. Accordingly, the techniques described herein should be understood as illustrative and not limiting, and may be modified, extended, or combined while remaining within the scope of the appended claims.

In some embodiments, the policy enforcement system 100 operates as a unified architecture capable of governing workflows associated with human users, artificial intelligence assisted users, and artificial intelligence agents using the common policy enforcement computing device 106 and the policy enforcement engine 204. In such embodiments, the same core sequence of operations described with reference to blocks 302, 304, 306, 308, 310, and 316 of method 300 may be applied across different workflow types, while the manner in which performance of the selected intervention modality is caused may differ depending on whether the workflow is human-driven, agent-driven, or shared between a human user and an artificial intelligence system. For example, as described with reference to method 400, a human user branch may cause a user interface intervention associated with a target interface element, while, as described with reference to method 500, an artificial intelligence agent branch may cause a machine-readable intervention response that alters, delays, denies, or redirects execution of a proposed action. In this manner, the disclosed architecture may apply common sequence-aware policy evaluation and risk assessment logic across multiple actor types while supporting different runtime intervention mechanisms.

In some embodiments, workflows may include an intermediate artificial intelligence assisted mode in which a human user remains actively involved while an artificial intelligence system proposes, drafts, recommends, or partially performs actions within a monitored workflow. For example, an artificial intelligence assistant may suggest text for insertion into a message, recommend an upload target, summarize content for transmission, propose a tool invocation, or prepare a multi-step task that is later reviewed or completed by a human user. In such embodiments, the policy enforcement system 100 may obtain action data associated with both human-originated inputs and artificial-intelligence-generated recommendations and may treat the resulting workflow as a shared or hybrid workflow for purposes of sequence context retrieval and policy evaluation. In some implementations, an intervention associated with an artificial intelligence assisted workflow may include both a machine-readable response directed to the artificial intelligence component and a user interface intervention rendered to the human user through the user or application computing device 102, such that the human user may confirm, revise, deny, or redirect the proposed action in view of the identified policy violation risk.

In some embodiments, the policy enforcement system 100 may operate through one or more different control points depending on the deployment environment, the type of software interface being governed, or the type of actor associated with a workflow. For example, observation and intervention may occur at an endpoint associated with a user or application computing device 102, at a gateway associated with a language-model service or other artificial intelligence services computing device 110, at an application programming interface layer, at a proxy service, at an agent software development kit layer, at an operating system event layer, or at another control point through which action data, proposed actions, or intervention outputs may be observed or controlled. In some embodiments, the policy enforcement computing device 106 may cooperate with multiple such control points simultaneously, such that some workflows are observed at a visible interface while other workflows are observed through structured tool calls, gateway requests, or runtime execution hooks. In this manner, the disclosed techniques are not limited to visible overlay-based deployments and may be adapted to environments in which only structured action data or proxy-visible interactions are available.

In some embodiments, the policy enforcement system 100 may coordinate a multi-step intervention sequence across two or more computing devices associated with a common workflow, a common user, or both. For example, the policy enforcement system 100 may detect a proposed action at a first computing device, cause a first intervention or guidance output at the first computing device, and then cause a second intervention, approval, verification, or remediation step at a second computing device while maintaining workflow state across the sequence. In some embodiments, a user may begin a workflow at a desktop or laptop computing device, receive guidance or a blocking intervention at that device, transition to a mobile computing device to complete an approval, verification, or confirmation action, and then return to the first computing device or continue the workflow elsewhere using state maintained by the policy enforcement system 100. In some embodiments, such coordinated multi-device intervention may include desktop notifications, mobile push notifications, calls, voice-based verification interactions, approval prompts, remediation prompts, or combinations thereof, and the policy enforcement system 100 may maintain common workflow identifiers, state records, audit records, or intervention-history records across the participating devices.

In some embodiments, the workflow context store 214b or another sequence context data structure may implement a multi-tier memory architecture used to maintain workflow state across different time horizons. For example, the workflow context store 214b may include a hot-context tier associated with a current workflow session, a warm-memory tier associated with a recent time window, and a cold-memory tier associated with longer-term historical workflow activity across sessions. The sequence context retrieval sub-engine 204c may retrieve sequence context from one or more such tiers depending on recency, relevance, graph proximity, semantic similarity, or other retrieval criteria. In some embodiments, when memory utilization associated with a hot-context tier satisfies a threshold condition, one or more patterns, policy interpretation learnings, near-miss indicators, or other workflow history elements may be flushed or compacted into a warm-memory tier or cold-memory tier prior to removal from the hot-context tier. Such multi-tier memory management may improve the ability of the policy enforcement system 100 to preserve both immediate workflow context and longer-term context without requiring all context data to remain in a single runtime memory structure.

In some embodiments, the policy enforcement system 100 may maintain trust or provenance information associated with persistent memory used by an artificial intelligence agent. For example, the workflow context store 214b, the policy store 214c, or the risk and intervention store 214d may store information identifying whether a memory item, instruction, suggestion, or persistent context element originated from a trusted source, an untrusted source, a human principal, a prior workflow, or another actor. The policy evaluation sub-engine 204e or the risk assessment sub-engine 204f may use such trust or provenance information when evaluating whether a proposed action by an artificial intelligence agent is policy-compliant or whether a persistent memory item should be treated as suspicious, untrusted, stale, or subject to additional validation. In some embodiments, such memory-provenance logic may reduce the risk that an artificial intelligence agent later acts on seeded, malicious, stale, or otherwise untrusted persistent instructions carried over from an earlier workflow.

In some embodiments, the same nominal action may be evaluated differently depending on the retrieved sequence context even when the visible interface element, action type, or destination appears superficially identical. For example, a send action, upload action, paste action, or tool call action may be permissible when evaluated in the context of a routine workflow sequence but may be identified as risky when evaluated in the context of a sequence indicating prior access to confidential information, regulated records, sensitive internal communications, or another policy-relevant prior action. In such embodiments, the sequence context retrieved at block 306 of method 300, block 406 of method 400, or block 506 of method 500 may alter the policy significance of a proposed action in a way that would not be captured by isolated action classification alone. This sequence-dependent evaluation may be implemented using the event knowledge graph, hybrid retrieval functions, prior workflow records, or other context structures described with reference to the sequence context retrieval sub-engine 204c and the workflow context store 214b.

In some embodiments, the intervention control sub-engine 204g may select among multiple different intervention modalities beyond the overlay-based and machine-readable response examples illustrated in methods 400 and 500. For example, the selected intervention modality may include a user interface overlay, a warning dialog, a confirmation dialog, a delayed-execution prompt, a notification, a chat-based response, a mobile push message, an approval request, an audio or voice alert, a browser-extension message, an application programming interface callback, a queued or held action state, or another modality capable of altering how a proposed action proceeds. In various embodiments, the selected modality may depend on the actor type, available control points, action reversibility, latency requirements, deployment architecture, confidence associated with the risk output, or other contextual parameters. In this manner, overlay-based intervention for human workflows and structured guided rejection for artificial intelligence agent workflows should be understood as illustrative embodiments rather than exclusive intervention techniques.

In some embodiments, intervention with respect to artificial intelligence agents may be carried out through multiple different enforcement mechanisms in addition to, or instead of, transmission of a structured deny or redirect response. For example, the policy enforcement system 100 may enforce a selected intervention modality by blocking or modifying a tool call, intercepting an application programming interface request, delaying transmission of a proposed action, redirecting execution through an alternate workflow path, holding an action for human approval, enforcing a pre-execution hook, causing a proxy service to reject or modify a request, or otherwise preventing the artificial intelligence agent from completing an action in the absence of policy-compliant conditions. In some embodiments, the machine-readable intervention response generated by the agent response sub-engine 204h may be provided to a runtime environment, tool-execution environment, proxy, gateway, or workflow orchestrator that enforces the corresponding intervention outcome at a control point external to the policy enforcement computing device 106.

In some embodiments, the policy enforcement system 100 may operate in connection with a human principal associated with an artificial intelligence agent. For example, the artificial intelligence agent may act on behalf of, at the direction of, or within an authority scope associated with the human principal, and prior actions or approvals of the human principal may form part of the sequence context retrieved by the sequence context retrieval sub-engine 204c. In some embodiments, when the intervention modality selected at block 514 of method 500 includes delay, denial, redirection, hold, or escalation, the intervention control sub-engine 204g or the agent response sub-engine 204h may cause a notification, approval request, or other downstream output to be provided to one or more external approval and response computing devices 112 associated with the human principal. Such outputs may permit the human principal to approve an alternative action, deny further execution, adjust a workflow objective, or otherwise participate in governance of the artificial intelligence agent workflow.

In some embodiments, the disclosed techniques may be implemented across multiple operating systems, endpoint types, and interface technologies. For example, the user or application computing devices 102 may include devices executing different operating systems, browser engines, application frameworks, or remote-session environments, and the policy enforcement computing device 106 may use one or more platform-specific observation, rendering, or interception implementations under a common abstraction layer provided by the policy enforcement engine 204. In such embodiments, the logic used by the policy compiler sub-engine 204d, the policy evaluation sub-engine 204e, the risk assessment sub-engine 204f, the intervention control sub-engine 204g, and the agent response sub-engine 204h may remain substantially consistent across platforms while the underlying capture, window-tracking, input-interception, or rendering mechanics vary according to operating system-specific or interface-specific requirements.

In some embodiments, the intervention control sub-engine 204g may be configured to reduce false blocks or other unnecessary disruptions by selecting intervention modalities according to confidence, uncertainty, reversibility, or other factors associated with the risk output. For example, low-confidence situations may result in logging, warning, or approval routing outcomes rather than automatic hard-block outcomes, while higher-confidence situations may result in stronger interventions such as blocking, denial, or forced redirection. In some embodiments, the graduated intervention logic described with reference to block 316 of method 300, block 414 of method 400, and block 514 of method 500 may be implemented such that the policy enforcement system 100 preserves a conservative enforcement posture where uncertainty exists while still maintaining real-time risk-reduction capabilities.

In some embodiments, the policy enforcement system 100 may further calibrate intervention timing, pipeline latency targets, compute allocation, model selection, or other runtime processing characteristics based on an irreversibility class, severity class, or mistake-ranking associated with a proposed action. For example, proposed actions associated with rapid and materially irreversible consequences, such as transmission, publication, deletion, release, or other difficult-to-reverse actions, may be assigned more aggressive latency targets, earlier-triggered evaluation, higher-priority processing, or stronger intervention readiness than proposed actions associated with slower or more reversible consequences. In some embodiments, the policy enforcement engine 204 may therefore allocate additional resources, invoke lower-latency models, rely on precomputed context, or prioritize a hot path for actions ranked as higher-risk or less reversible, while permitting longer-latency enrichment, advisory intervention, or lower-cost evaluation paths for other action classes. In this manner, the disclosed system may calibrate technical operation of the pipeline to the expected consequence profile of the proposed action rather than treating all workflows as having identical timing requirements.

In some embodiments, one or more artificial intelligence models used by the artificial intelligence services computing device 110 or by components of the policy enforcement computing device 106 may be developed, evaluated, or tuned using synthetic workflow data, scenario generators, replay environments, or validation environments configured to simulate human user workflows, artificial intelligence assisted workflows, or artificial intelligence agent workflows. For example, synthetic scenarios may be used to evaluate how the structured observation sub-engine 204b, the sequence context retrieval sub-engine 204c, the risk assessment sub-engine 204f, the intervention control sub-engine 204g, or the agent response sub-engine 204h respond to variations in sequence context, interface state, actor type, action types, or policy conditions. In some embodiments, such synthetic evaluation infrastructure may support policy tuning, model validation, regression testing, or controlled comparison of intervention strategies across different deployment environments.

In some embodiments, the various techniques described with reference to methods 300, 400, 500, and 600 may be combined in different ways depending on deployment requirements, workflow types, interface technologies, or policy enforcement objectives. For example, a deployment may emphasize endpoint overlay interventions described with reference to method 400, artificial intelligence agent guided rejection described with reference to method 500, policy compilation and policy constraint generation described with reference to method 600, or sequence-aware runtime evaluation described with reference to method 300, while still using common workflow history structures, shared policy stores, or shared risk-assessment logic. Accordingly, the disclosed architecture should be understood as supporting multiple complementary embodiments rather than requiring all implementations to include identical control points, intervention mechanisms, or actor types.

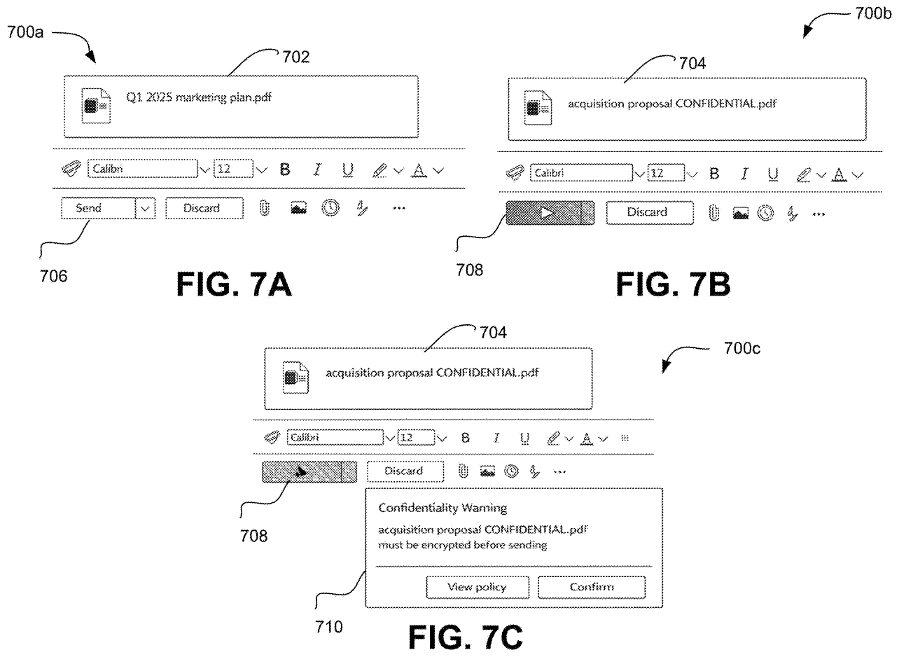

FIGS. 7A, 7B, and 7C illustrate an example sequence of user-interface states 700a, 700b, and 700c, respectively, associated with evaluation of different documents for transmission through a third-party software interface. In the illustrated embodiment, FIG. 7A depicts a first interface state 700a, FIG. 7B depicts a second interface state 700b, and FIG. 7C depicts a third interface state 700c. As shown on sheet 7, the first interface state 700a includes a first attached document 702 and a send control 706, while the second and third interface states 700b and 700c include a second attached document 704, an intervention-associated send-region control 708, and, in FIG. 7C, an overlay or intervention window 710.

In various embodiments, the first interface state 700a illustrated in FIG. 7A corresponds to a workflow in which a document identified as “Q1 2025 marketing plan. pdf” is attached for transmission through an email-composition or similar communication interface. In such embodiments, the policy enforcement system 100 may obtain action data associated with the displayed interface, generate structured observations identifying the attached document 702 and the send control 706, retrieve sequence context associated with the proposed transmission, and evaluate the proposed action using the techniques described with reference to blocks 302, 304, 306, 308, and 310 of method 300. In the example shown, the first attached document 702 may be determined not to satisfy a policy condition requiring intervention, and the send control 706 may remain available without a blocking or warning overlay. Thus, FIG. 7A may illustrate an example non-intervention state in which the policy enforcement computing device 106 permits completion of the proposed transmission without causing a user-interface intervention.

In various embodiments, the second interface state 700b illustrated in FIG. 7B corresponds to a workflow in which a different attached document, shown as “acquisition proposal CONFIDENTIAL.pdf,” is identified as the second attached document 704. In such embodiments, the policy enforcement system 100 may determine that the presence of the second attached document 704, alone or in combination with retrieved sequence context, is associated with a policy-violation risk sufficient to justify intervention. For example, the structured observation sub-engine 204b may detect content indicating a confidentiality designation, the sequence context retrieval sub-engine 204c may identify prior workflow activity associated with access to sensitive information, and the policy evaluation sub-engine 204e together with the risk assessment sub-engine 204f may generate a risk output indicating that transmission of the second attached document 704 requires additional controls. As shown in FIG. 7B, the send-region control 708 may then appear in a modified or controlled state, thereby indicating that the ordinary transmission path has been altered pending further intervention handling. In some embodiments, FIG. 7B may represent an intermediate state in which the intervention control sub-engine 204g has selected a user-interface intervention modality but has not yet caused presentation of the full overlay or intervention window 710 shown in FIG. 7C.

In various embodiments, the third interface state 700c illustrated in FIG. 7C depicts a further stage of intervention associated with the second attached document 704. As shown on sheet 7, the overlay or intervention window 710 includes a confidentiality warning and explanatory text indicating that the attached document is to be encrypted before sending, together with selectable controls labeled “View policy” and “Confirm.” In such embodiments, the intervention control sub-engine 204g may determine an overlay position associated with the send-region control 708 or another target interface element and may cause rendering of the intervention window 710 in association with the communication interface. The intervention window 710 may therefore function as an example of the user-interface intervention described with reference to blocks 414, 416, 418, and 420 of method 400. In some embodiments, the intervention window 710 may block or delay completion of the proposed transmission until the user acknowledges the warning, views additional policy information, confirms an alternate compliant action, or otherwise satisfies a condition for continued workflow execution.

In some embodiments, the contrast between FIG. 7A and FIGS. 7B-7C illustrates that different documents, even when attached through a common interface and associated with a similar send action, may result in different intervention outcomes depending on document characteristics, workflow context, or both. For example, the first attached document 702 in FIG. 7A may correspond to ordinary business material that does not trigger a policy condition, whereas the second attached document 704 in FIGS. 7B and 7C may correspond to confidential or otherwise policy-restricted content that triggers a warning, hold, encryption requirement, approval requirement, or other intervention. In some embodiments, the policy enforcement system 100 may therefore distinguish between superficially similar transmission events by evaluating not only the existence of an attachment, but also semantic or contextual properties of the attached document and prior workflow events associated with that document.

In some embodiments, the intervention sequence shown across FIGS. 7B and 7C may be interpreted as a graduated intervention process. For example, FIG. 7B may correspond to an initial controlled state in which the send path is visually altered or temporarily constrained, while FIG. 7C may correspond to a subsequent state in which a more explicit overlay or intervention window 710 is presented with explanatory text and selectable compliance-related options. In such embodiments, the policy enforcement system 100 may select among different intervention modalities, visual emphasis techniques, or user-decision options based on the confidence associated with the risk output, the severity of the applicable policy condition, the reversibility of the proposed action, or the availability of a compliant alternative such as encryption before sending.

In some embodiments, user interaction with the overlay or intervention window 710 may further affect subsequent workflow processing. For example, selection of the “View policy” control may cause retrieval or presentation of additional policy information from the data repository 104 or one or more external approval and response computing devices 112, while selection of the “Confirm” control may indicate agreement to a compliant next step, such as transmitting an encrypted version of the second attached document 704 or otherwise satisfying a policy condition prior to sending. In various embodiments, interaction with the intervention window 710, the resulting workflow state, and any associated approval or audit information may be stored in the risk and intervention store 214d or the processing and auditing log 214e for later review, auditing, or policy tuning.

In some embodiments, FIGS. 7A-7C should therefore be understood as illustrating example user-interface manifestations of the sequence-aware policy enforcement techniques described herein. More specifically, FIG. 7A may illustrate a non-intervention example, FIG. 7B may illustrate an intervention-triggering example associated with a different attached document, and FIG. 7C may illustrate a resulting overlay-based warning and control interface that modifies how the user may proceed. Accordingly, FIGS. 7A-7C provide concrete examples of how the policy enforcement system 100 may evaluate proposed document-transmission actions and selectively cause user-interface interventions at third-party software interfaces based on policy-violation risk.

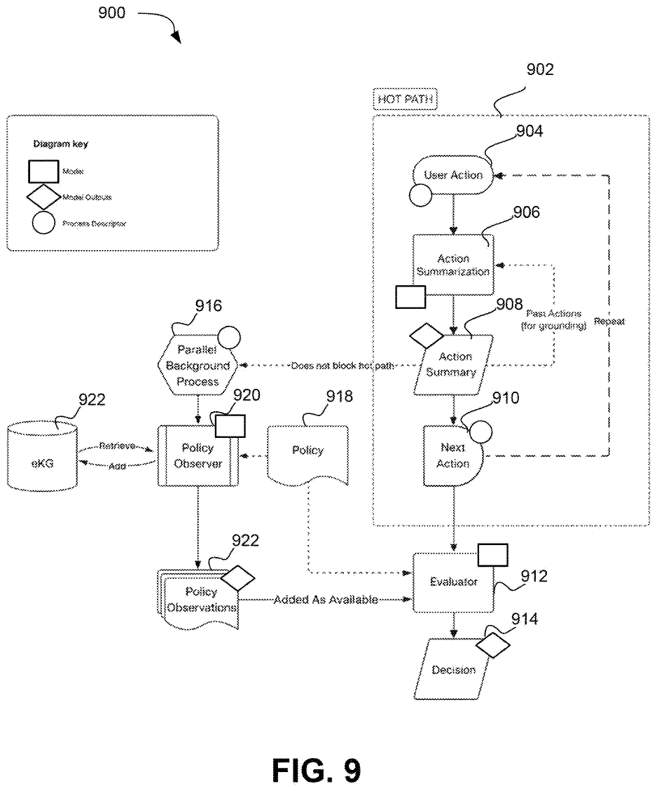

FIG. 9 illustrates an embodiment of a processing architecture 900 for evaluating a proposed action using a latency-sensitive hot path 902 together with a parallel background process 916, consistent with some embodiments of the present disclosure. As shown on sheet 9, the hot path 902 includes a user action element 904, an action summarization element 906, an action summary element 908, a next action element 910, an evaluator 912, and a decision element 914. FIG. 9 further illustrates the parallel background process 916, a policy input 918, a policy observer 920, and one or more data stores 922, such as an event knowledge graph and policy observation records. In various embodiments, the processing architecture 900 provides a non-sequential or partially parallel arrangement in which a current intervention decision may be generated through the hot path 902 while additional evidence and contextual enrichment are accumulated through the parallel background process 916 without blocking the hot path 902.

In various embodiments, the user action element 904 may correspond to detection of an observed or proposed action performed by a human user, an artificial intelligence agent, or an artificial intelligence-assisted user within a monitored workflow. The user action element 904 may be generated from one or more perception channels, such as screen-state capture, operating-system event monitoring, application-programming-interface observation, or combinations thereof. In some embodiments, once the user action element 904 is identified, the action summarization element 906 may process information associated with the observed action to generate the action summary element 908. For example, the action summarization element 906 may convert raw action information, screenshots, event streams, or interface observations into a structured or semi-structured summary suitable for downstream evaluation. In various embodiments, the action summary element 908 may incorporate or be grounded by past actions associated with the current workflow, as reflected by the dashed grounding and repeat paths shown in FIG. 9, thereby enabling the system to interpret a current proposed action in view of earlier workflow activity rather than in isolation.

In various embodiments, the next action element 910 may represent a current or imminent action state derived from the action summary element 908 and suitable for runtime evaluation. The evaluator 912 may then process the next action element 910 together with available policy information and contextual information to generate the decision element 914. In some embodiments, the evaluator 912 may determine whether the next action is risky, non-compliant, uncertain, or permissible, and may generate a corresponding decision output usable for intervention selection, guidance generation, logging, or other downstream control operations. In various embodiments, because the evaluator 912 operates on the hot path 902, the evaluator 912 may use contextual information already available at the time of evaluation while additional information may continue to be accumulated in parallel for later use. Thus, FIG. 9 illustrates that the processing architecture 900 need not wait for all possible enrichment operations to finish before producing a current decision element 914.

In various embodiments, the parallel background process 916 may operate concurrently with the hot path 902 to generate additional policy-relevant or context-relevant observations. For example, the parallel background process 916 may invoke or coordinate the policy observer 920, which may receive the policy input 918, retrieve context from one or more data stores 922, and generate one or more policy observations stored or represented in the data stores 922. In some embodiments, the data stores 922 may include an event knowledge graph, evidence records, policy observation records, or other workflow-history structures capable of storing actions, semantic observations, policy-linked artifacts, and relationships among them. As indicated by the arrows labeled “Retrieve” and “Add” in FIG. 9, the policy observer 920 may retrieve information from the event knowledge graph or other data stores 922 and may add newly generated observations, relationships, or evidence back into those stores. In various embodiments, the output of the policy observer 920 may be provided to the evaluator 912 as available, such that accumulated policy observations may improve later decisions even if they were not required to produce an earlier decision on the hot path 902.

In some embodiments, the policy input 918 may correspond to a policy specification, compiled policy constraints, natural-language constraint input, structured enforcement logic, or another policy-related artifact that guides generation of policy observations by the policy observer 920. In various embodiments, the policy observer 920 may compare policy-related context against workflow evidence associated with the current user action element 904, the action summary element 908, one or more prior actions, or other retrieved contextual information and may generate policy observations identifying whether the observed workflow appears relevant to one or more risk conditions, policy conditions, escalation conditions, or intervention conditions. In some embodiments, the policy observations generated by the policy observer 920 may accumulate over time such that the system becomes progressively better informed regarding the significance of later actions in the same workflow, related workflows, or later sessions associated with the same user, artificial intelligence agent, artifact, or project.

In various embodiments, FIG. 9 therefore illustrates a technical distinction between a first path that is optimized to support near-real-time decision generation and a second path that enriches context in parallel without preventing the first path from producing a current evaluation. Such an arrangement may improve latency, scalability, and deployment practicality because the system may intervene quickly when a proposed action becomes sufficiently risky while still allowing richer contextual evidence to be accumulated and reused over time. In some embodiments, the evidence generated through the parallel background process 916 may be stored in the event knowledge graph or other data stores 922 and later used to ground subsequent action summaries, inform subsequent evaluator decisions, or support explanation, traceability, auditability, and model refinement. Accordingly, the processing architecture 900 of FIG. 9 illustrates how the disclosed system may support both real-time risk prevention and progressive context enrichment in a unified yet at least partially parallel processing framework.

Thus, embodiments of the present disclosure provide computer-implemented systems and methods that improve the functioning of computer security, interface-control, and workflow-governance systems by evaluating proposed actions at third-party software interfaces using sequence-aware policy assessment and adaptive intervention. Rather than relying on isolated action classification, static application-specific controls, or unconstrained runtime interpretation of policy text, the disclosed techniques obtain action data associated with proposed actions, generate structured observations identifying interface and workflow context, retrieve prior workflow activity from one or more sequence-context data structures, and apply deterministic policy constraints together with risk-assessment logic to determine whether intervention is appropriate. The disclosed architecture further causes different intervention modalities depending on workflow type, including overlay-based or other user-interface interventions for human-user workflows and machine-readable intervention responses for artificial-intelligence-agent workflows, while supporting shared policy logic, shared workflow context, and shared risk evaluation across human, artificial intelligence-assisted, and agent-driven interactions. By incorporating sequence-aware context retrieval, policy compilation, risk-based intervention selection, and controlled runtime enforcement within a structured policy-enforcement pipeline, the disclosed techniques improve the ability of computing systems to distinguish between superficially similar actions that carry different policy significance, reduce reliance on brittle application-specific modifications, and enable scalable, reproducible, and auditable policy-enforcement decisions. Accordingly, the embodiments described herein provide concrete technical improvements to computer security and interface-control systems by improving how proposed actions are evaluated, how policy constraints are applied, and how interventions are caused in distributed computing environments involving third-party software interfaces, thereby improving operation of such systems through real-time, context-aware control of human and artificial-intelligence-agent workflows.

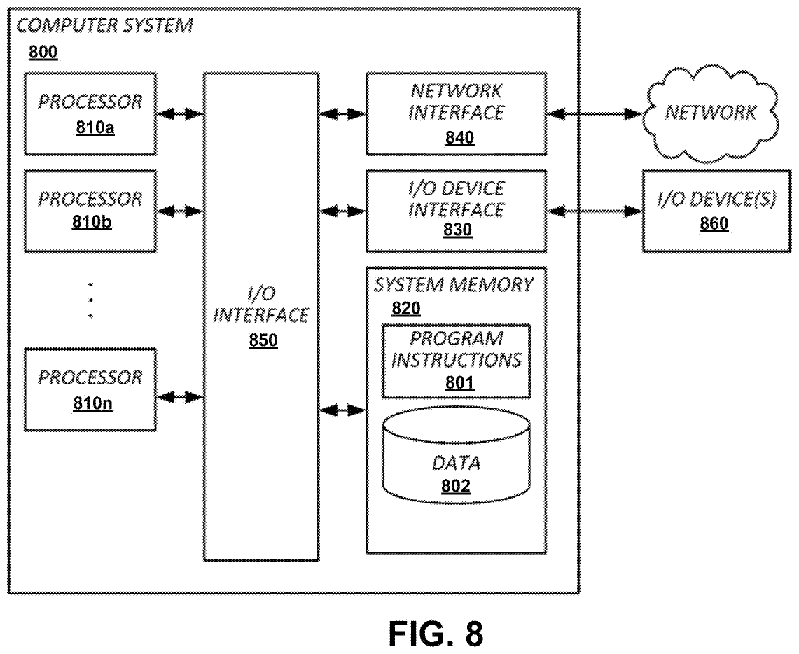

FIG. 8 is a diagram that illustrates an exemplary computing system 800 in accordance with embodiments of the present technique. A single computing device is shown, but some embodiments of a computer system may include multiple computing devices that communicate over a network, for instance in the course of collectively executing various parts of a distributed application. Various portions of systems and methods described herein, may include or be executed on one or more computer systems similar to computing system 800. Further, processes and modules described herein may be executed by one or more processing systems similar to that of computing system 800.

Computing system 800 may include one or more processors (e.g., processors 810a-810n) coupled to system memory 820, an input/output I/O device interface 830, and a network interface 840 via an input/output (I/O) interface 850. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 800. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 820). Computing system 800 may be a uni-processor system including one processor (e.g., processor 810a), or a multi-processor system including any number of suitable processors (e.g., 810a-810n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 800 may include a plurality of computing devices (e.g., distributed computer systems) to implement various processing functions.

I/O device interface 830 may provide an interface for connection of one or more I/O devices 860 to computing system 800. I/O devices may include devices that receive input (e.g., from a user) or output information (e.g., to a user). I/O devices 860 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 860 may be connected to computing system 800 through a wired or wireless connection. I/O devices 860 may be connected to computing system 800 from a remote location. I/O devices 860 located on remote computer system, for example, may be connected to computing system 800 via a network and network interface 840.

Network interface 840 may include a network adapter that provides for connection of computing system 800 to a network. Network interface 840 may facilitate data exchange between computing system 800 and other devices connected to the network. Network interface 840 may support wired or wireless communication. The network may include an electronic communication network, such as the Internet, a local area network (LAN), a wide area network (WAN), a cellular communications network, or the like.

System memory 820 may be configured to store program instructions 801 or data 802. Program instructions 801 may be executable by a processor (e.g., one or more of processors 810a-810n) to implement one or more embodiments of the present techniques. Instructions 801 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 820 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 820 may include a non-transitory computer readable storage medium that may have program instructions stored thereon that are executable by a computer processor (e.g., one or more of processors 810a-810n) to cause the subject matter and the functional operations described herein. A memory (e.g., system memory 820) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 850 may be configured to coordinate I/O traffic between processors 810a-810n, system memory 820, network interface 840, I/O devices 860, and/or other peripheral devices. I/O interface 850 may perform protocol, timing, or other data transformations to convert data signals from one component (e.g., system memory 820) into a format suitable for use by another component (e.g., processors 810a-810n). I/O interface 850 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 800 or multiple computing systems 800 configured to host different portions or instances of embodiments. Multiple computing systems 800 may provide for parallel or sequential processing/execution of one or more portions of the techniques described herein.

Those skilled in the art will appreciate that computing system 800 is merely illustrative and is not intended to limit the scope of the techniques described herein. Computing system 800 may include any combination of devices or software that may perform or otherwise provide for the performance of the techniques described herein. For example, computing system 800 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 800 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 800 may be transmitted to computing system 800 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
Clause 1. A non-transitory computer-readable medium storing instructions that, when executed by one or more processors, cause the one or more processors to perform operations comprising: monitoring, by a computing system, a workflow associated with a user at a computing environment; obtaining, by the computing system, action data indicative of a proposed action within the workflow; generating, by the computing system from the action data, structured observations identifying at least an action type, a context of the proposed action, and one or more interface or system elements associated with the proposed action; retrieving, by the computing system from a data structure storing prior workflow activity, sequence context associated with the proposed action, wherein the sequence context includes one or more prior actions related to the proposed action across one or more applications or services; evaluating, by the computing system, the proposed action against policy constraints using the structured observations and the sequence context to generate a risk output indicative of whether the proposed action presents a policy violation risk; selecting, by the computing system and based at least in part on the risk output, an intervention modality for the proposed action; and causing, by the computing system, performance of the intervention modality.
Clause 2. The non-transitory computer-readable medium of clause 1, wherein the instructions, when executed by the one or more processors, cause the computing system to perform the evaluating and the selecting without modification to an underlying third-party application through which the proposed action is initiated.
Clause 3. The non-transitory computer-readable medium of clause 1, wherein the action data includes at least one of: screen-state data associated with a graphical user interface, operating system event data, application programming interface data, tool call data, prompt data, response data, or agent action request data.
Clause 4. The non-transitory computer-readable medium of clause 3, wherein the instructions, when executed by the one or more processors, cause the computing system to generate the structured observations by processing captured screen-state data with a computer vision model to detect a target interface element and to extract visible application state, visible document content, or user interface element state.
Clause 5. The non-transitory computer-readable medium of clause 4, wherein the instructions, when executed by the one or more processors, cause the computing system to obtain the action data by capturing the screen-state data in response to at least one of a mouse down event, a keyboard event, or a typing pause satisfying an idle threshold.
Clause 6. The non-transitory computer-readable medium of clause 1, wherein the instructions, when executed by the one or more processors, cause the computing system to retrieve the sequence context by querying an event knowledge graph that stores action nodes associated with prior workflow activity and edges indicating at least one of temporal relationships, causal relationships, or cross application data flow relationships.
Clause 7. The non-transitory computer-readable medium of clause 6, wherein the instructions, when executed by the one or more processors, cause the computing system to retrieve the sequence context by applying a hybrid retrieval function that combines graph proximity, semantic similarity, and temporal recency to rank prior actions for use in evaluating the proposed action.
Clause 8. The non-transitory computer-readable medium of clause 1, wherein the policy constraints are generated by compiling a natural language policy specification into natural language constraint representations before runtime evaluation of the proposed action.
Clause 9. The non-transitory computer-readable medium of clause 8, wherein the instructions, when executed by the one or more processors, cause the computing system to compile the natural language policy specification by decomposing the natural language policy specification into a plurality of scenario classes, each scenario class including an action type, a context specification, and a sequence pattern.
Clause 10. The non-transitory computer-readable medium of clause 9, wherein the instructions, when executed by the one or more processors, cause the computing system to compile the natural language policy specification by further detecting contradictions, overlaps, or ambiguities among the plurality of scenario classes and surfacing the contradictions, overlaps, or ambiguities for human resolution before deployment of the natural language constraint representations.
Clause 11. The non-transitory computer-readable medium of clause 10, wherein the instructions, when executed by the one or more processors, cause the computing system to compile the natural language policy specification by further generating a human-readable preview of an enforcement behavior for at least one of the plurality of scenario classes and receiving explicit approval of the enforcement behavior before deployment of the natural language constraint representations.
Clause 12. The non-transitory computer-readable medium of clause 1, wherein the risk output includes at least a risk score and a confidence value.
Clause 13. The non-transitory computer-readable medium of clause 12, wherein the instructions, when executed by the one or more processors, cause the computing system to select the intervention modality by applying a graduated intervention model in which different intervention modalities are selected for different confidence bands of the confidence value.
Clause 14. The non-transitory computer-readable medium of clause 13, wherein the graduated intervention model includes: at a first confidence band, allowing the proposed action without user visible intervention or imposing a blocking intervention; at a second confidence band, presenting a non-blocking warning or confirmation dialog; at a third confidence band, routing the proposed action for human confirmation; and at a fourth confidence band, recording the proposed action without user visible intervention.
Clause 15. The non-transitory computer-readable medium of clause 1, wherein the user is a human user or an artificial intelligence agent, wherein, when the user is the human user, the instructions, when executed by the one or more processors, cause the computing system to cause performance of the intervention modality by causing presentation of a user interface intervention associated with a target interface element corresponding to the proposed action, and wherein, when the user is the artificial intelligence agent, the instructions, when executed by the one or more processors, cause the computing system to cause performance of the intervention modality by causing transmission of a machine-readable intervention response configured to alter, delay, deny, or redirect execution of the proposed action by the artificial intelligence agent.
Clause 16. The non-transitory computer-readable medium of clause 15, wherein, when the user is the human user, the instructions, when executed by the one or more processors, cause the computing system to cause performance of the intervention modality by rendering an operating system-level overlay window above a third-party application and positioning the operating system-level overlay window relative to the target interface element.
Clause 17. The non-transitory computer-readable medium of clause 16, wherein the instructions, when executed by the one or more processors, cause the computing system to cause performance of the intervention modality by causing the operating system-level overlay window to intercept input events directed to a region of a graphical user interface covered by the operating system-level overlay window to block or delay completion of the proposed action.
Clause 18. The non-transitory computer-readable medium of clause 16, wherein the instructions, when executed by the one or more processors, cause the computing system to cause performance of the intervention modality by causing the operating system-level overlay window to track movement, resize, or scroll behavior of an application window containing the target interface element to maintain spatial alignment with the target interface element.
Clause 19. The non-transitory computer-readable medium of clause 15, wherein the machine-readable intervention response includes a decision field, a confidence field, a reason field identifying a violated policy constraint, an alternatives field identifying one or more permitted alternative actions, and an escalation field identifying whether human escalation is available.
Clause 20. The non-transitory computer-readable medium of claim 6, wherein the instructions, when executed by the one or more processors, cause the computing system to: obtain first screen-state data associated with a first application, wherein the first screen-state data shows first content; store, in the data structure storing prior workflow activity, a representation of the first content; subsequently obtain second content associated with a second application; identify semantic similarity between the second content and the representation of the first content; and generate the risk output based at least in part on the identified semantic similarity, wherein no file-transfer event, clipboard event, or data-movement application-programming-interface event links the first application and the second application.
Clause 21. A computer-implemented method, comprising: monitoring, by a computing system, a workflow associated with a user at a computing environment; obtaining, by the computing system, action data indicative of a proposed action within the workflow; generating, by the computing system from the action data, structured observations identifying at least an action type, a context of the proposed action, and one or more interface or system elements associated with the proposed action; retrieving, by the computing system from a data structure storing prior workflow activity, sequence context associated with the proposed action, wherein the sequence context includes one or more prior actions related to the proposed action across one or more applications or services; evaluating, by the computing system, the proposed action against policy constraints using the structured observations and the sequence context to generate a risk output indicative of whether the proposed action presents a policy violation risk; selecting, by the computing system based at least in part on the risk output, an intervention modality for the proposed action; and causing, by the computing system, performance of the intervention modality.
Clause 22. The method of claim 21, implementing any one or more of the embodiments recited in clauses 2-20.
Clause 23. A system, including: one or more processors; and a memory storing instructions that when executed by the processors cause the processor to perform the above-mentioned processes in clauses 1-20.

What is claimed is:

1. A non-transitory computer-readable medium storing instructions that, when executed by one or more processors, cause the one or more processors to perform operations comprising:
monitoring, by a computing system, a workflow associated with a user at a computing environment;
obtaining, by the computing system, action data indicative of a proposed action within the workflow;
generating, by the computing system from the action data, structured observations identifying at least an action type, a context of the proposed action, and one or more interface or system elements associated with the proposed action;
retrieving, by the computing system from a data structure storing prior workflow activity, sequence context associated with the proposed action, wherein the sequence context includes one or more prior actions related to the proposed action across one or more applications or services;
evaluating, by the computing system, the proposed action against policy constraints using the structured observations and the sequence context to generate a risk output indicative of whether the proposed action presents a policy violation risk;
selecting, by the computing system and based at least in part on the risk output, an intervention modality for the proposed action; and
causing, by the computing system, performance of the intervention modality.

2. The non-transitory computer-readable medium of claim 1, wherein the instructions, when executed by the one or more processors, cause the computing system to perform the evaluating and the selecting without modification to an underlying third-party application through which the proposed action is initiated.

3. The non-transitory computer-readable medium of claim 1, wherein the action data includes at least one of: screen-state data associated with a graphical user interface, operating system event data, application programming interface data, tool call data, prompt data, response data, or agent action request data.

4. The non-transitory computer-readable medium of claim 3, wherein the instructions, when executed by the one or more processors, cause the computing system to generate the structured observations by processing captured screen-state data with a computer vision model to detect a target interface element and to extract visible application state, visible document content, or user interface element state.

5. The non-transitory computer-readable medium of claim 4, wherein the instructions, when executed by the one or more processors, cause the computing system to obtain the action data by capturing the screen-state data in response to at least one of a mouse down event, a keyboard event, or a typing pause satisfying an idle threshold.

6. The non-transitory computer-readable medium of claim 1, wherein the instructions, when executed by the one or more processors, cause the computing system to retrieve the sequence context by querying an event knowledge graph that stores action nodes associated with prior workflow activity and edges indicating at least one of temporal relationships, causal relationships, or cross application data flow relationships.

7. The non-transitory computer-readable medium of claim 6, wherein the instructions, when executed by the one or more processors, cause the computing system to retrieve the sequence context by applying a hybrid retrieval function that combines graph proximity, semantic similarity, and temporal recency to rank prior actions for use in evaluating the proposed action.

8. The non-transitory computer-readable medium of claim 1, wherein the instructions, when executed by the one or more processors, cause the computing system to:
obtain first screen-state data associated with a first application, wherein the first screen-state data shows first content;
store, in the data structure storing prior workflow activity, a representation of the first content;
subsequently obtain second content associated with a second application;
identify semantic similarity between the second content and the representation of the first content; and
generate the risk output based at least in part on the identified semantic similarity, wherein no file-transfer event, clipboard event, or data-movement application-programming-interface event links the first application and the second application.

9. The non-transitory computer-readable medium of claim 1, wherein the policy constraints are generated by compiling a natural language policy specification into natural language constraint representations before runtime evaluation of the proposed action.

10. The non-transitory computer-readable medium of claim 9, wherein the instructions, when executed by the one or more processors, cause the computing system to compile the natural language policy specification by decomposing the natural language policy specification into a plurality of scenario classes, each scenario class including an action type, a context specification, and a sequence pattern.

11. The non-transitory computer-readable medium of claim 10, wherein the instructions, when executed by the one or more processors, cause the computing system to compile the natural language policy specification by further detecting contradictions, overlaps, or ambiguities among the plurality of scenario classes and surfacing the contradictions, overlaps, or ambiguities for human resolution before deployment of the natural language constraint representations.

12. The non-transitory computer-readable medium of claim 11, wherein the instructions, when executed by the one or more processors, cause the computing system to compile the natural language policy specification by further generating a human-readable preview of an enforcement behavior for at least one of the plurality of scenario classes and receiving explicit approval of the enforcement behavior before deployment of the natural language constraint representations.

13. The non-transitory computer-readable medium of claim 1, wherein the risk output includes at least a risk score and a confidence value, and wherein the instructions, when executed by the one or more processors, cause the computing system to select the intervention modality by applying a graduated intervention model in which different intervention modalities are selected for different confidence bands of the confidence value.

14. The non-transitory computer-readable medium of claim 13, wherein the graduated intervention model includes:
at a first confidence band, allowing the proposed action without user visible intervention;
at a second confidence band, presenting a non-blocking warning or confirmation dialog;
at a third confidence band, routing the proposed action for human confirmation; and
at a fourth confidence band, recording the proposed action without user visible intervention.

15. The non-transitory computer-readable medium of claim 1, wherein the user is a human user or an artificial intelligence agent, wherein, when the user is the human user, the instructions, when executed by the one or more processors, cause the computing system to cause performance of the intervention modality by causing presentation of a user interface intervention associated with a target interface element corresponding to the proposed action, and wherein, when the user is the artificial intelligence agent, the instructions, when executed by the one or more processors, cause the computing system to cause performance of the intervention modality by causing transmission of a machine-readable intervention response configured to alter, delay, deny, or redirect execution of the proposed action by the artificial intelligence agent.

16. The non-transitory computer-readable medium of claim 15, wherein, when the user is the human user, the instructions, when executed by the one or more processors, cause the computing system to cause performance of the intervention modality by rendering an operating system-level overlay window above a third-party application and positioning the operating system-level overlay window relative to the target interface element.

17. The non-transitory computer-readable medium of claim 16, wherein the instructions, when executed by the one or more processors, cause the computing system to cause performance of the intervention modality by causing the operating system-level overlay window to intercept input events directed to a region of a graphical user interface covered by the operating system-level overlay window to block or delay completion of the proposed action.

18. The non-transitory computer-readable medium of claim 16, wherein the instructions, when executed by the one or more processors, cause the computing system to cause performance of the intervention modality by causing the operating system-level overlay window to track movement, resize, or scroll behavior of an application window containing the target interface element to maintain spatial alignment with the target interface element.

19. The non-transitory computer-readable medium of claim 15, wherein the machine-readable intervention response includes a decision field, a confidence field, a reason field identifying a violated policy constraint, an alternatives field identifying one or more permitted alternative actions, and an escalation field identifying whether human escalation is available.

20. A computer-implemented method, comprising:
monitoring, by a computing system, a workflow associated with a user at a computing environment;
obtaining, by the computing system, action data indicative of a proposed action within the workflow;
generating, by the computing system from the action data, structured observations identifying at least an action type, a context of the proposed action, and one or more interface or system elements associated with the proposed action;
retrieving, by the computing system from a data structure storing prior workflow activity, sequence context associated with the proposed action, wherein the sequence context includes one or more prior actions related to the proposed action across one or more applications or services;
evaluating, by the computing system, the proposed action against policy constraints using the structured observations and the sequence context to generate a risk output indicative of whether the proposed action presents a policy violation risk;
selecting, by the computing system based at least in part on the risk output, an intervention modality for the proposed action; and
causing, by the computing system, performance of the intervention modality.
